(19) United States
(12) Patent Application Publication
(10) Pub. No.: US 2026/0221154 A1
(43) Pub. Date: Jul. 30, 2026

(54) MAGNETIC RECORDING MEDIUM

(71) Applicant: Sony Group Corporation, Tokyo (JP)

(72) Inventor: Sogo OIKAWA, Tokyo (JP)

(21) Appl. No.: 19/140,629

(22) PCT Filed: Jan. 11, 2024
(86) PCT No.: PCT/JP2024/000342

§ 371 Date: Jun. 18, 2025

(30) Foreign Application Priority Data
Jan. 31, 2023 (JP) 2023-013201

(51) Int. Cl. G11B 5/706

(52) U.S. Cl. CPC G11B 5/70615

(57) ABSTRACT

An object of the present technology is to provide a magnetic recording medium that has excellent electromagnetic conversion characteristics and can suppress an increase in head friction during traveling many times.

The present technology provides a magnetic recording medium including a magnetic layer, in which a Cl/Fe atomic ratio α of a magnetic layer surface measured by an X-ray photoelectron spectrometer is 0.60 or more and 5.70 or less. Furthermore, in the present technology, the N/Fe atomic ratio β of the magnetic layer surface measured by an X-ray photoelectron spectrometer may be 0.16 or more and 0.98 or less, and the (Cl+N)/Fe atomic ratio γ of the surface of the magnetic layer measured by the X-ray photoelectron spectrometer may be 0.60 or more and 6.69 or less.

### TECHNICAL FIELD

The present technology relates to a magnetic recording medium.

### BACKGROUND ART

The amount of data collected and stored has been greatly increased, for example, with the development of IoT, big data, artificial intelligence, and the like. A magnetic recording medium is often used as a medium for recording a large amount of data.

Various technologies have been proposed for a magnetic recording medium. For example, Patent Document 1 below discloses a magnetic recording medium that improves head wear and head contamination by adjusting the average protrusion height of an abrasive on the surface of a magnetic layer (hereinafter, referred to as a “magnetic surface”) to 15 nm or less, and achieves both electromagnetic conversion characteristics and durability.

Furthermore, Patent Document 2 below discloses a magnetic recording medium in which the surface roughness Ra of a magnetic layer is 15 nm or less, and the number of protrusions of 30 nm is adjusted to 125,000 to 250,000/cm² to improve electromagnetic conversion characteristics, traveling performance, and durability.

### CITATION LIST

### Patent Document

Patent Document 1: Japanese Patent Application Laid-Open No. 6-52541
Patent Document 2: Japanese Patent Application Laid-Open No. 6-12651

### SUMMARY OF THE INVENTION

### Problems to be Solved by the Invention

An object of the present technology is to provide a magnetic recording medium that has excellent electromagnetic conversion characteristics and can suppress an increase in head friction during traveling many times.

### Solutions to Problems

The present technology provides
a magnetic recording medium including a magnetic layer, in which
a Cl/Fe atomic ratio α of a magnetic layer surface measured by an X-ray photoelectron spectrometer is 0.60 or more and 5.70 or less.

The Cl/Fe atomic ratio α of the magnetic layer surface measured by the X-ray photoelectron spectrometer may be 0.65 or more and 5.70 or less.

The N/Fe atomic ratio β of the magnetic layer surface measured by the X-ray photoelectron spectrometer may be 0.16 or more and 0.98 or less.

The magnetic layer surface may have an (Cl+N)/Fe atomic ratio γ of 0.60 or more and 6.69 or less as measured by the X-ray photoelectron spectrometer.

A P/B ratio in the magnetic layer may be 4 or more.

The magnetic layer may contain magnetic powder having an Fe atom.

The magnetic powder having an Fe atom may be hexagonal ferrite particles.

The magnetic layer may contain a binder having a Cl atom.

The binder having a Cl atom may be a chlorine-based resin.

The magnetic layer may contain a binder having an N atom.

The average particle volume of the magnetic powder may be 1600 nm³ or less.

A squareness ratio in a vertical direction of the magnetic recording medium is 50% or more.

The magnetic recording medium may have an average thickness tr of 5.5 μm or less.

The magnetic layer may have a thickness of 80 nm or less.

The average thickness t_{B} of the base layer may be 4.8 μm or less.

The magnetic recording medium may have an SNR of 1.4 dB or more.

The magnetic layer, the underlayer, and the base layer may be included in this order.

The underlayer may contain a non-magnetic powder.

Furthermore, the present technology also provides a magnetic recording cartridge including the magnetic recording medium, the magnetic recording medium accommodated in a case in a state of being wound around a reel.

### BRIEF DESCRIPTION OF DRAWINGS

FIG. 1 is a cross-sectional view illustrating a configuration of a magnetic recording medium according to a first embodiment.

FIG. 2A is a view illustrating an example of a shape of a particle of a magnetic powder.

FIG. 2B is an example of a TEM photo of a sample cross section.

FIG. 2C is another example of a TEM photo of a sample cross section.

FIG. 3 is a graph showing the relationship between the number of scans in Cl measurement and the Cl 2p integrated intensity.

FIG. 4 is a graph showing a relationship between a measurement spectrum of Cl and a peak intensity.

FIG. 5 is a schematic view illustrating a configuration of a recording and reproducing apparatus.

FIG. 6 is an exploded perspective view illustrating an example of a configuration of a magnetic recording cartridge.

FIG. 7 is an exploded perspective view illustrating an example of a configuration of a magnetic recording cartridge of a modified example.

FIG. 8 is a schematic view illustrating a method of measuring a dynamic friction coefficient.

### MODE FOR CARRYING OUT THE INVENTION

Hereinafter, preferred embodiments for implementing the present technology will be described. Note that embodiments described below illustrate representative embodiments of the present technology, and the scope of the present technology is not limited only to these embodiments.

The present technology will be described in the following order.
1. Description of Present Technology
2. First Embodiment
(1) Configuration of Magnetic Recording Medium
(2) Description of Each Layer
(3) Physical Properties and Structure
(4) Method of Manufacturing Magnetic Recording
Medium
(5) Recording and Reproducing Apparatus
(6) Modified Examples
3. Second Embodiment
(1) Embodiment of Magnetic Recording Cartridge
(2) Modified Example of Magnetic Recording Cartridge
4. Examples

In the present description, in a case where a measurement method is described without a particular description of the measurement environment, the measurement is performed under an environment of 25° C.±2° C. and 50% RH±5% RH.

### 1. Description of Present Technology

The present inventors have conducted intensive studies focusing on the surface of the magnetic layer (hereinafter, referred to as a “magnetic surface”). As a result, it has been found that the amount of the binder present on the magnetic surface affects the electromagnetic conversion characteristics of the magnetic recording medium.

The present inventor has found that the electromagnetic conversion characteristics of the magnetic recording medium can be improved by particularly adjusting the Cl/Fe atomic ratio, the N/Fe atomic ratio, and the (Cl+N)/Fe atomic ratio on the surface of the magnetic layer to be in optimal ranges.

That is, the magnetic recording medium of the present technology includes a magnetic layer, and the Cl/Fe atomic ratio α of the surface of the magnetic layer measured by the X-ray photoelectron spectrometer is 0.60 or more and 5.70 or less.

The Cl/Fe atomic ratio α of the magnetic layer surface measured by the X-ray photoelectron spectrometer on the magnetic layer surface indicates the abundance of the binder with respect to the magnetic powder on the magnetic layer surface, and more specifically, is a parameter indicating the abundance of the binder containing a chlorine atom (Cl) present on the magnetic layer surface. That is, when a large amount of the binder is present on the surface of the magnetic layer, the Cl/Fe atomic ratio α increases. On the surface of the magnetic layer, it has been found that the filling rate of the magnetic powder is improved and the electromagnetic conversion characteristics are enhanced as the abundance of the binder is small, but the dispersibility worsens and the electromagnetic conversion characteristics are deteriorated when the abundance of the binder is too small.

In the magnetic recording medium of the present technology, the Cl/Fe atomic ratio on the magnetic surface is controlled within the range described above. Therefore, electromagnetic conversion characteristics of the magnetic recording medium are improved, and an increase in friction during traveling many times is suppressed.

In an embodiment of the present technology, the N/Fe atomic ratio β of the magnetic layer surface measured by the X-ray photoelectron spectrometer may be 0.16 or more and 0.98 or less. The N/Fe atomic ratio β of the magnetic layer surface measured by the X-ray photoelectron spectrometer on the magnetic layer surface indicates the abundance of the binder with respect to the magnetic powder on the magnetic layer surface, and more specifically, is a parameter indicating the abundance of the binder containing a nitrogen atom (N) present on the magnetic layer surface. That is, when a large amount of the binder is present on the surface of the magnetic layer, the N/Fe atomic ratio β increases. On the surface of the magnetic layer, it has been found that the filling rate of the magnetic powder is improved and the electromagnetic conversion characteristics are enhanced as the abundance of the binder is small, but the dispersibility worsens and the electromagnetic conversion characteristics are deteriorated when the abundance of the binder is too small. In the magnetic recording medium of the present technology, the N/Fe atomic ratio on the magnetic surface may be controlled within the range described above. Therefore, electromagnetic conversion characteristics of the magnetic recording medium are improved, and an increase in friction during traveling many times is suppressed.

In another embodiment of the present technology, the (Cl+N)/Fe atomic ratio γ of the magnetic layer surface measured by the X-ray photoelectron spectrometer may be 0.60 or more and 6.69 or less. In the magnetic recording medium of the present embodiment, the (Cl+N)/Fe atomic ratio on the magnetic surface is controlled. Therefore, electromagnetic conversion characteristics of the magnetic recording medium are improved, and an increase in friction during traveling many times is suppressed.

The magnetic recording medium according to the present technology may be preferably an elongated magnetic recording medium, and may be, for example, a magnetic recording tape (particularly an elongated magnetic recording tape).

The magnetic recording medium according to the present technology may include a magnetic layer, a non-magnetic layer (underlayer), a base layer, and a back layer in this order, and may include other layers in addition to these layers. The other layers may be appropriately selected according to the type of the magnetic recording medium. The magnetic recording medium may be a coating type magnetic recording medium, that is, may be a magnetic recording medium manufactured by applying a material (particularly, coating material) for forming another layer to a base layer and drying the material.

The average thickness (average total thickness) tr of the magnetic recording medium according to the present technology may be, for example, 5.5 μm or less, preferably 5.4 μm or less, more preferably 5.3 μm or less, 5.2 μm or less, 5.1 μm or less, 5.0 μm or less, 4.9 μm or less, or 4.8 μm or less, and even more preferably 4.6 μm or less or 4.4 μm or less. Since the magnetic recording medium may be thin as described above, for example, the tape length wound in one magnetic recording cartridge can be made longer, and therefore, the recording capacity per magnetic recording cartridge can be increased. The lower limit of the average thickness (average total thickness) tr of the magnetic recording medium is not particularly limited, and is, for example, 3.5 μm≤t_{T}. A method for measuring the average thickness of the magnetic recording medium will be described in 2. (3) below.

The average thickness tₘ of the magnetic layer of the magnetic recording medium according to the present technology can be preferably 80 nm or less, more preferably 70 nm or less, still more preferably 60 nm or less, or 50 nm or less, and even more preferably 40 nm or less. The lower limit of the average thickness tₘ of the magnetic layer is not particularly limited, and can be preferably 30 nm or more. A method of measuring the average thickness of the magnetic layer will be described in 2. (3) below.

The average thickness of the underlayer (also referred to as a non-magnetic layer) of the magnetic recording medium according to the present technology can be 1250 nm or less, preferably 1100 nm or less, 1000 nm or less, 900 nm or less, more preferably 800 nm or less, 700 m or less, or 600 nm or less, and still more preferably 500 nm or less. Furthermore, the lower limit of the average thickness of the underlayer is not particularly limited, and can be preferably 200 nm or more, and more preferably 300 nm or more. A method of measuring the average thickness of the underlayer will be described in 2. (3) below.

The average thickness of the base layer (also referred to as a base material layer) of the magnetic recording medium according to the present technology can be preferably 4.8 μm or less, 4.5 μm or less, more preferably 4.2 μm or less, 4.0 μm or less, 3.8 μm or less, or 3.6 μm or less, and even more preferably 3.4 μm or less, 3.2 μm or less, or 3.0 μm or less. Furthermore, the lower limit of the average thickness of the base layer is not particularly limited, but may be, for example, preferably 2.0 μm or more, 2.2 μm or more, 2.4 μm or more, and more preferably 2.5 μm or more. A method of measuring the average thickness of the base layer will be described in 2. (3) below.

The average thickness of the back layer of the magnetic recording medium according to the present technology can be preferably 0.6 μm or less, more preferably 0.5 μm or less, and even more preferably 0.4 μm or less, 0.3 μm or less, 0.25 μm or less, or 0.2 μm or less. Furthermore, the lower limit of the average thickness of the back layer is not particularly limited, but may be, for example, preferably 0.1 μm or more, and more preferably 0.15 μm or more. A method of measuring the average thickness of the back layer will be described in 2. (3) below.

The magnetic recording medium according to the present technology can have, for example, at least one data band and at least two servo bands. The number of data bands can be, for example, 2 to 10, particularly 3 to 6, and more particularly 4 or 5. The number of servo bands can be, for example, 3 to 11, particularly 4 to 7, and more particularly 5 or 6. These servo bands and data bands may be arranged, for example, so as to extend in the longitudinal direction of the elongated magnetic recording medium (particularly, magnetic recording tape), and in particular, so as to be substantially parallel. The data bands and the servo bands can be provided in the magnetic layer. Examples of the magnetic recording medium having the data bands and the servo bands as described above include a magnetic recording tape conforming to the Linear Tape-Open (LTO) standard. That is, the magnetic recording medium according to the present technology may be a magnetic recording tape conforming to the LTO standard. For example, the magnetic recording medium according to the present technology may be a magnetic recording tape conforming to LTO8 or a later standard (for example, LTO9, LTO10, LTO11, LTO12, or the like).

The width of the elongated magnetic recording medium (particularly, magnetic recording tape) according to the present technology can be, for example, 5 mm to 30 mm, particularly 7 mm to 25 mm, more particularly 10 mm to 20 mm, and still more particularly 11 mm to 19 mm. The length of the elongated magnetic recording medium (particularly, magnetic recording tape) can be, for example, 500 m to 1500 m. For example, the tape width conforming to the LTO8 standard is 12.65 mm, and the length is 960 m.

### 2. First Embodiment

### (1) Configuration of Magnetic Recording Medium

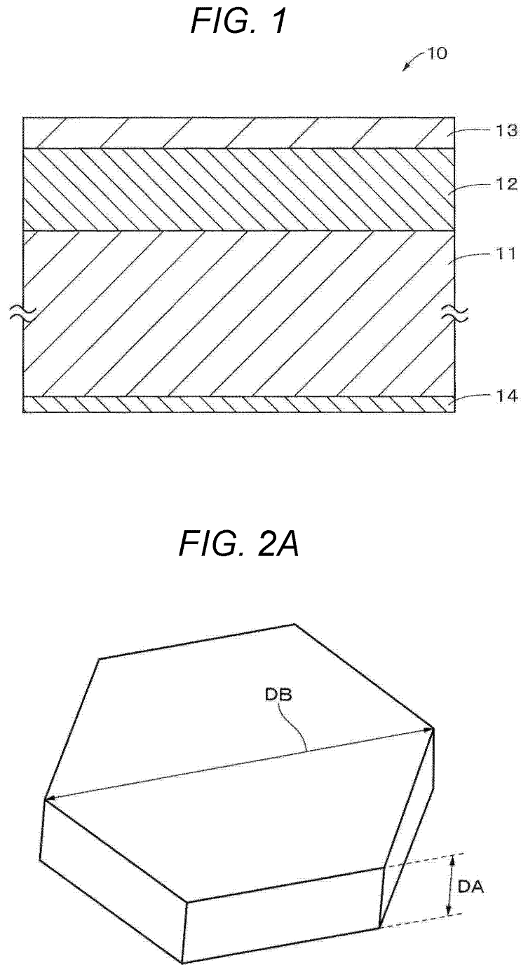

First, a configuration of a magnetic recording medium 10 according to a first embodiment will be described with reference to FIG. 1. The magnetic recording medium 10 is, for example, a magnetic recording medium subjected to vertical orientation processing. The magnetic recording medium 10 includes an elongated base layer (also referred to as a substrate) 11, an underlayer 12 provided on one principal surface of the base layer 11, a magnetic layer (also referred to as a recording layer) 13 provided on the underlayer 12, and a back layer 14 provided on the other principal surface of the base layer 11, as illustrated in FIG. 1. Hereinafter, among both the principal surfaces of the magnetic recording medium 10, the surface the side on which the magnetic layer 13 is provided will be referred to as a magnetic surface, and the surface opposite side from the magnetic surface (the surface on the side which the back layer 14 is provided) will be referred to as a back surface.

The magnetic recording medium 10 has an elongated shape and travels in the longitudinal direction during recording and reproducing. Furthermore, the magnetic recording medium 10 may be configured to be capable of recording a signal at the shortest recording wavelength of preferably 60 nm or less, more preferably 50 nm or less, still more preferably 45 nm or less, and particularly preferably 40 nm or less, and can be used, for example, in a recording and reproducing apparatus whose shortest recording wavelength is in the above-described range. The recording and reproducing apparatus may include a ring type head as a recording head. The recording track width is, for example, 2 μm or less.

### (2) Description of Each Layer

### (Base Layer)

The base layer 11 can function as a support body of the magnetic recording medium 10, and is, for example, an elongated flexible non-magnetic substrate, and particularly, may be a non-magnetic film. The base layer 11 can contain, for example, at least one of a polyester-based resin, a polyolefin-based resin, a cellulose derivative, a vinyl-based resin, an aromatic polyether ketone resin, or other polymer resins. In a case where the base layer 11 contains two or more of the above-described materials, the two or more materials may be mixed, copolymerized, or layered.

The polyester-based resin may be, for example, one or a mixture of two or more of polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylene bisphenoxycarboxylate. According to a preferred embodiment of the present technology, the base layer 11 may include PET or PEN.

The polyolefin-based resin may be, for example, one or a mixture of two or more of polyethylene (PE) and polypropylene (PP).

The cellulose derivative may be, for example, one or a mixture of two or more of cellulose diacetate, cellulose triacetate, cellulose acetate butyrate (CAB), and cellulose acetate propionate (CAP).

The vinyl-based resin may be, for example, one or a mixture of two or more of polyvinyl chloride (PVC) and polyvinylidene chloride (PVDC).

The aromatic polyether ketone resin may be, for example, one or a mixture of two or more of polyether ketone (PEK), polyether ether ketone (PEEK), polyether ketone ketone (PEKK), and polyether ether ketone ketone (PEEKK). According to a preferred embodiment of the present technology, the base layer 11 may include PEEK.

The other polymer resins may be, for example, one or a mixture of two or more of a polyamide, nylon (PA), an aromatic polyamide, aramid (aromatic PA), a polyimide (PI), an aromatic polyimide (aromatic PI), a polyamideimide (PAI), an aromatic polyamideimide (aromatic PAI), polybenzoxazole such as Zylon (registered trademark) (PBO), a polyether, a polyether ester, polyether sulfone (PES), polyether imide (PEI), polysulfone (PSF), polyphenylene sulfide (PPS), polycarbonate (PC), polyarylate (PAR), and a polyurethane (PU).

The base layer may include a resin containing no chlorine, and particularly may include a polyester-based resin containing no chlorine. Note that the base layer may include a chlorine-containing resin.

### (Magnetic Layer)

The magnetic layer 13 may be, for example, a perpendicular recording layer. The magnetic layer 13 contains a magnetic powder. The magnetic layer 13 can further contain a binder. The magnetic layer 13 may further contain non-magnetic particles. The magnetic layer 13 may further contain, for example, an additive such as a lubricant, a corrosion inhibitor, or the like, as needed.

The magnetic layer 13 is preferably a vertically oriented magnetic layer. In the present description, the word “vertical orientation” indicates that the squareness ratio S1 measured in the longitudinal direction (traveling direction) of the magnetic recording medium 10 is 35% or less.

### (Magnetic Powder)

Examples of the magnetic particles forming the magnetic powder contained in the magnetic layer 13 can include hexagonal ferrite, epsilon type iron oxide (ε-iron oxide), Co-containing spinel ferrite, gamma hematite, magnetite, chromium dioxide, cobalt-coated iron oxide, a metal, and the like, but are not limited thereto. The magnetic powder may be one or a combination of two or more thereof. The magnetic powder can preferably contain hexagonal ferrite, ε-iron oxide, or Co-containing spinel ferrite. The magnetic powder is particularly preferably hexagonal ferrite. The hexagonal ferrite can particularly preferably contain at least one of Ba or Sr. The ε-iron oxide can particularly preferably contain at least one of Al or Ga. These magnetic particles may be appropriately selected by those skilled in the art on the basis of factors such as the method of manufacturing the magnetic layer 13, a specification of the tape, a function of the tape, and the like.

A shape of the magnetic particles depends on a crystal structure of the magnetic particles. For example, barium ferrite (BaFe) and strontium ferrite can have a hexagonal plate-like shape. The ε-iron oxide can have a spherical shape. Cobalt ferrite can have a cubic shape. The metal can have a spindle shape. These magnetic particles are oriented in a manufacturing process of the magnetic recording medium 10.

The average aspect ratio of the magnetic powder may be, for example, 1.0 or more and 3.0 or less, and may be 1.0 or more and 2.9 or less.

### (Embodiment in Which Magnetic Powder Contains Hexagonal Ferrite)

The magnetic powder contains, for example, hexagonal ferrite particles as magnetic particles. The magnetic powder is preferably crystal-oriented preferentially in the vertical direction of the magnetic recording medium 10. In the present specification, the vertical direction (thickness direction) of the magnetic recording medium 10 represents the thickness direction of the magnetic recording medium 10.

The hexagonal ferrite particles have, for example, a plate-like shape such as a hexagonal plate-like shape or a columnar shape such as a hexagonal column-like shape (however, the thickness or height is smaller than the major axis of the plate surface or the bottom surface). In the present specification, the hexagonal plate-like shape includes a substantially hexagonal plate-like shape. Furthermore, the hexagonal column includes a substantially hexagonal column-like shape.

The hexagonal ferrite particles contain Fe and a metal M1 other than Fe. The metal M1 contains an alkaline earth metal. The alkaline earth metal contains at least Sr. The alkaline earth metal may further contain at least one of Ba and Ca in addition to Sr, and preferably contains Ba among these metals. The metal M1 may contain Pb in addition to the alkaline earth metal.

The hexagonal ferrite particles may further contain a metal M2 in addition to Fe and the metal M1. The metal M2 can substitute a site of Fe in the crystal structure of the hexagonal ferrite. The metal M2 contains, for example, one selected from the group consisting of a rare earth element, a transition metal element other than Fe, and a metal element of Group 13 of the periodic table, and among these, at least one selected from the group consisting of Ti, Al, and Nd is preferable.

In the present embodiment, the rare earth element refers to Y, La, Ce, Pr, Nd, Pm, Sm, Eu, Gd, Tb, Dy, Ho, Er, Tm, Yb, and Lu. The transition metal element other than Fe refers to Ti, V, Cr, Mn, Co, Ni, Cu, Zn, Zr, Nb, Mo, Ru, Hf, Ta, and W. The metal element of Group 13 of the periodic table refers to Al, Ga, In, and Tl.

Specifically, the hexagonal ferrite particles may be, for example, barium ferrite particles or strontium ferrite particles. In the present disclosure, the strontium ferrite particles refer to hexagonal ferrite particles having an atomic ratio of Sr to the metal M1 of 50 atom or more. Therefore, the hexagonal ferrite particles containing Sr and the metal M1 other than Sr are contained in the strontium ferrite particles in a case where the atomic ratio of Sr to the metal M1 is 50 atom % or more. For example, in a case where the metal M1 contains Sr and Ba, hexagonal ferrite particles in which the atomic ratio of Sr to the total amount of Sr and Ba is 50 atom % or more are referred to as barium ferrite particles.

In the present embodiment, the barium ferrite particles refer to hexagonal ferrite particles in which the atomic ratio of Ba to the metal M1 is 50 atom % or more. Therefore, the hexagonal ferrite particles containing Ba and the metal M1 other than Ba are contained in the barium ferrite particles in a case where the atomic ratio of Ba to the metal M1 is 50 atom % or more. For example, in a case where the metal M1 contains Sr and Ba, hexagonal ferrite particles in which the atomic ratio of Ba to the total amount of Sr and Ba is 50 atom % or more are referred to as barium ferrite particles.

More specifically, the hexagonal ferrite may have an average composition represented by the following general formula (1).

$$Sr ( 1 - x ) α x Fe ( 12 - y ) β y {O}_{19} \qquad ( 1 )$$

(In the formula (1), a represents at least one selected from the group consisting of Ba, Ca, and Pb. B represents at least one selected from the group consisting of rare earth elements, transition metal elements other than Fe, and metal elements of Group 13 of the periodic table. x is within a range of 0≤x≤0.9, preferably 0≤x≤0.7, still more preferably 0.3≤x≤0.7. y represents 0≤y≤0.80, preferably 0.22≤y≤0.80, more preferably 0.26≤y≤0.80.

In a case where the magnetic powder includes a powder of hexagonal ferrite particles, the average particle size of the magnetic powder can be preferably 30 nm or less, more preferably 25 nm or less, and even more preferably 20 nm or less, 18 nm or less, 16 nm or less, 14 nm or less, or 12 nm or less. The average particle size can be, for example, 8 nm or more, preferably 9 nm or more, and more preferably 10 nm or more. For example, the average particle size of the magnetic powder may be 8 nm or more and 30 nm or less, 8 nm or more and 25 nm or less, 9 nm or more and 20 nm or less, 9 nm or more and 16 nm or less, or 9 nm or more and 14 nm or less. If the average particle size of the magnetic powder is the above-described upper limit or less (for example, 50 nm or less, and particularly 30 nm or less), an excellent electromagnetic conversion characteristic (for example, SNR) can be obtained in the magnetic recording medium 10 having a high recording density. If the average particle size of the magnetic powder is the above-described lower limit or more (for example, 10 nm or more, and preferably 12 nm or more), the dispersibility of the magnetic powder is further improved, and a more excellent electromagnetic conversion characteristic (for example, SNR) can be obtained.

In a case where the magnetic powder includes a powder of hexagonal ferrite particles, the average aspect ratio of the magnetic powder can be preferably 1.0 or more and 3.0 or less, more preferably 1.0 or more and 2.8 or less, and even more preferably 1.5 or more and 2.5 or less. If the average aspect ratio of the magnetic powder is within the above-described numerical range, aggregation of the magnetic powder can be suppressed and in addition, moreover, when the magnetic powder is vertically oriented in a step of forming the magnetic layer 13, resistance applied to the magnetic powder can be suppressed. As a result, the vertical orientation of the magnetic powder can be improved.

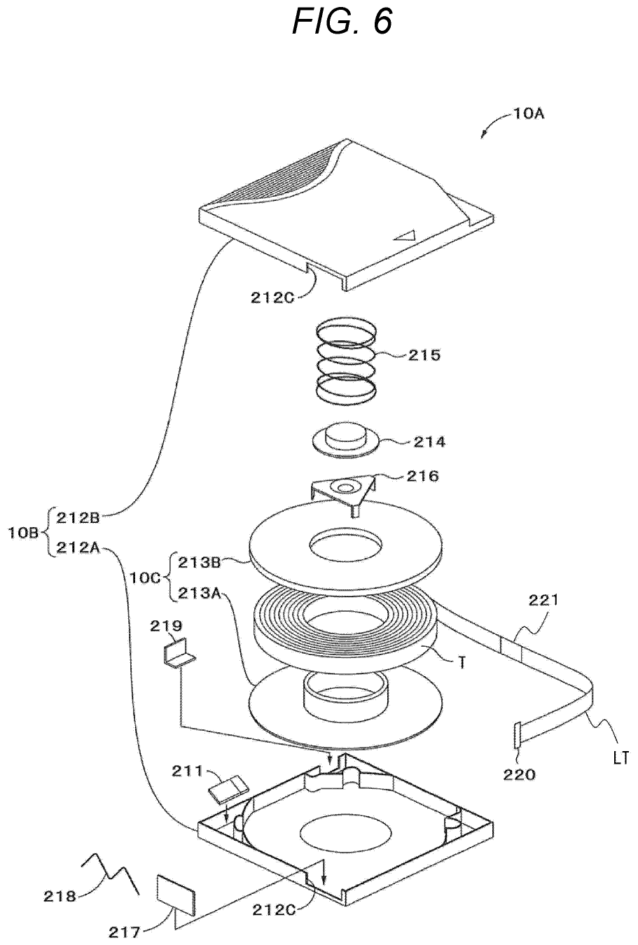

In a case where the magnetic powder includes a hexagonal ferrite particle powder, the average particle size and the average aspect ratio of the magnetic powder are determined as follows. First, a magnetic recording medium (hereinafter, also referred to as a “magnetic tape”) accommodated in a magnetic recording cartridge is unwound, and a magnetic tape to be measured is cut out by about 50 mm. For example, in the case of a magnetic recording cartridge 10A as illustrated in FIG. 6, the cut-out position may be a position 30 m from a connection portion 221 between the magnetic tape T and the leader tape LT in the longitudinal direction. Subsequently, the magnetic tape to be measured is processed with a FIB method and the like to perform thinning. In a case where the FIB method is used, formation of a carbon layer and a tungsten layer as protective films is performed as pre-processing for observing a TEM image of a cross section described below. The carbon layer is formed on a magnetic layer side surface and a back layer side surface of the magnetic tape with a vapor deposition method, and then the tungsten layer is further formed on the magnetic layer side surface with a vapor deposition method or a sputtering method. The thinning is performed in the length direction (longitudinal direction) of the magnetic tape. That is, the thinning is performed to form a cross section parallel to both the longitudinal direction and the thickness direction of the magnetic tape.

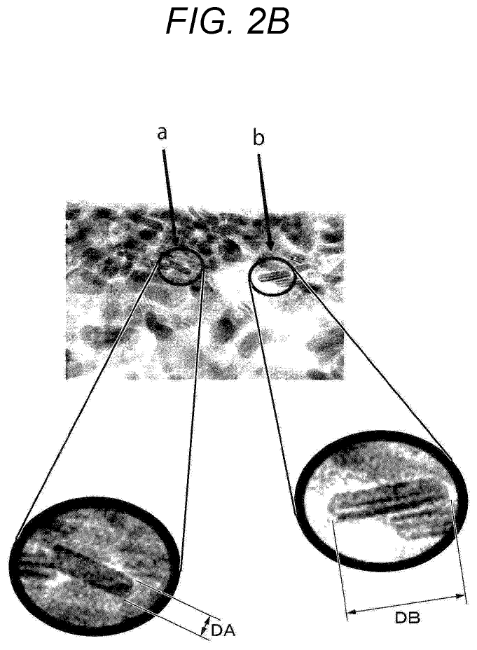

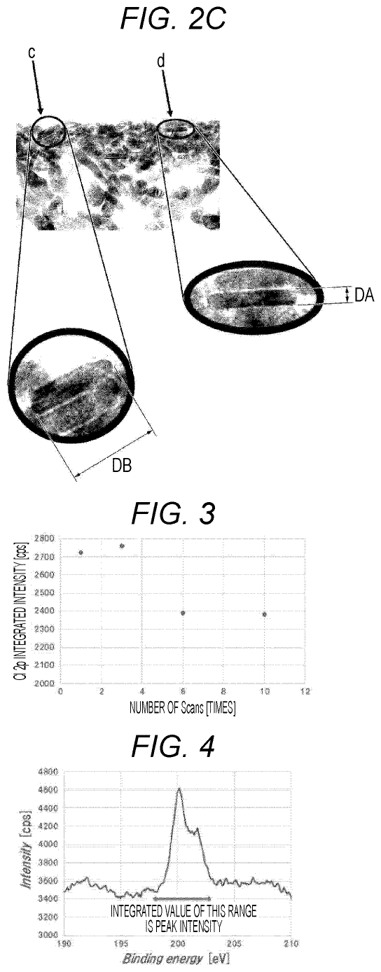

Using a transmission electron microscope (H-9500 manufactured by Hitachi High-Technologies Corporation), the above-described cross section of the obtained thin piece sample is observed at an acceleration voltage of 200 kV and a total magnification of 500,000 times so that the entire magnetic layer is included in the thickness direction of the magnetic layer, and a TEM photo is imaged. The number of TEM photos prepared is such that 50 particles can be extracted in which the plate diameter DB and the plate thickness DA (see FIG. 2A) shown below can be measured.

In the present description, the size of the hexagonal ferrite particle (hereinafter, referred to as the “particle size”) is determined as follows. In a case where a particle observed in the TEM photo has a plate shape or a columnar shape as illustrated in FIG. 2A (note that the thickness or height is smaller than the long diameter of the plate surface or the bottom surface), the value of the long diameter of the plate surface or the bottom surface is the value of the plate diameter DB. The value of the thickness or height of the particle observed in the TEM photo is the value of the plate thickness DA. In a case where a particle observed in the TEM photo has a hexagonal plate surface or bottom surface, the long diameter means the longest diagonal distance. In a case where the thickness or height of one particle is not constant in the particle, the maximum thickness or height of the particle is the plate thickness DA.

Next, 50 particles to be extracted from the imaged TEM photo are selected in accordance with the following criteria. A particle having a part out of the visual field of the TEM photo is not to be measured, and a particle having a clear outline and existing separately is to be measured. In a case where particles overlap, each particle is to be measured as a single particle when the boundary between the particles is clear and the entire shape of each particle can be determined, but a particle in which the boundary is not clear and the entire shape of the particle cannot be determined is not to be measured as the shape of the particle cannot be determined.

FIGS. 2B and 2C show an example of TEM photos. In these figures, for example, the particles indicated by the arrows a and d are selected because the plate thickness of each particle (thickness or height of each particle) DA can be clearly recognized. The plate thickness DA of each of the selected 50 particles is measured. The plate thicknesses DA thus obtained are simply averaged (arithmetically averaged) to obtain an average plate thickness DAₐᵥₑ. The average plate thickness DAₐᵥₑ is the average particle plate thickness.

Subsequently, the plate diameter DB of each magnetic powder is measured. In order to measure the plate diameter DB of the particles, 50 particles in which the plate diameter DB of each particle can be clearly recognized are selected from the imaged TEM photo. For example, in these figures, the particles, for example, indicated by the arrows b and c are selected because the plate diameter DB can be clearly recognized. The plate diameter DB of each of the selected 50 particles is measured. The plate diameters DB thus obtained are simply averaged (arithmetically averaged) to obtain an average plate diameter DBₐᵥₑ. The average plate diameter DBₐᵥₑ is the average particle size.

In a case where the magnetic powder includes a powder of hexagonal ferrite particles, the average particle volume of the magnetic powder may be preferably 1600 nm³ or less, more preferably 1500 nm³ or less, more preferably 1400 nm³ or less, and even more preferably 1200 nm³ or less, 1100 nm³ or less, or 1000 nm³ or less. The average particle volume of the magnetic powder can be preferably 500 nm³ or more, and more preferably 700 nm³ or more.

In a case where the average particle volume of the magnetic powder is the above-described upper limit or less (for example, 1600 nm³ or less), an excellent electromagnetic conversion characteristic (for example, SNR) can be obtained in the magnetic recording medium 10 having a high recording density. In a case where the average particle volume of the magnetic powder is the above-described lower limit or more (for example, 500 nm³ or more), the dispersibility of the magnetic powder is further improved, and a more excellent electromagnetic conversion characteristic (for example, SNR) can be obtained.

The average particle volume of the magnetic powder is determined as follows. First, as described regarding the method of calculating the average particle size of the magnetic powder, the average plate thickness DAₐᵥₑ and the average plate diameter DBₐᵥₑ are determined. Next, the average particle volume V of the magnetic powder is determined with the following formula.

$$V = \frac{3 \sqrt{3}}{8} \times {DA}_{ave} \times {DB}_{ave} \times {DB}_{ave} \qquad [ Mathematical Formula 1 ]$$

According to a particularly preferred embodiment of the present technology, the magnetic powder can be a barium ferrite magnetic powder or a strontium ferrite magnetic powder, and more preferably a barium ferrite magnetic powder. A barium ferrite magnetic powder contains iron oxide magnetic particles including barium ferrite as a main phase (hereinafter, referred to as “barium ferrite particles”). A barium ferrite magnetic powder has high reliability of data recording so that, for example, the coercivity does not deteriorate even in a high-temperature and high-humidity environment. From such a viewpoint, a barium ferrite magnetic powder is preferable as the magnetic powder.

The average particle size of the barium ferrite magnetic powder can be preferably 30 nm or less, more preferably 25 nm or less, and even more preferably 20 nm or less, 18 nm or less, 16 nm or less, 14 nm or less, or 12 nm or less. The average particle size can be, for example, 8 nm or more, preferably 9 nm or more, and more preferably 10 nm or more. For example, the average particle size of the magnetic powder may be 8 nm or more and 30 nm or less, 8 nm or more and 25 nm or less, 9 nm or more and 20 nm or less, 9 nm or more and 16 nm or less, or 9 nm or more and 14 nm or less.

Furthermore, the coercive force Hc1 measured in the thickness direction (vertical direction) of the magnetic recording medium 10 is preferably 2010 [Oe] or more and 3520 [Oe] or less, more preferably 2070 [Oe] or more and 3460 [Oe] or less, and still more preferably 2140 [Oe] or more and 3390 [Oe] or less.

### (Embodiment in Which Magnetic Powder Contains ε-Iron Oxide)

According to another preferred embodiment of the present technology, the magnetic powder can preferably include a powder of nanoparticles containing ε-iron oxide (hereinafter, referred to as “ε-iron oxide particles”). Even if fine particles, the ε-iron oxide particles can obtain high coercive force. ε-Iron oxide contained in the ε-iron oxide particles is preferably crystal-oriented preferentially in the thickness direction (vertical direction) of the magnetic recording medium 10.

The ε-iron oxide particles may have a structure of composite particles. More specifically, the ε-iron oxide particle includes an ε-iron oxide portion and a portion having soft magnetism or a portion having magnetism in which a saturation magnetization amount σs is higher than that of ε-iron oxide and a coercive force Hc is smaller than that of ε-iron oxide (hereinafter, referred to as a “portion having soft magnetism and the like”).

The ε-iron oxide portion contains ε-iron oxide. The ε-iron oxide contained in the ε-iron oxide portion preferably includes an ε-Fe₂O₃ crystal as a main phase, and more preferably includes a single-phase ε-Fe₂O₃.

The portion having soft magnetism and the like are in contact with at least a part of the ε-iron oxide portion. Specifically, the portion having soft magnetism and the like may partially cover the ε-iron oxide portion, and may partially cover an entire periphery of the ε-iron oxide portion.

The portion having soft magnetism (portion having magnetism in which the saturation magnetization amount σs is higher than that of ε-iron oxide and the coercive force Hc is smaller than that of ε-iron oxide) includes, for example, a soft magnetic material such as α-Fe, a Ni—Fe alloy, an Fe—Si—Al alloy, and the like. α-Fe may also be obtained by reducing ε-iron oxide contained in the ε-iron oxide portion.

Furthermore, the portion having soft magnetism may contain, for example, Fe₃O₄, γ-Fe₂O₃, spinel ferrite, and the like.

The ε-iron oxide particle includes the portion having soft magnetism described above and the like, such that the coercive force Hc of the ε-iron oxide particles (composite particles) as a whole can be adjusted to a coercive force Hc suitable for recording while maintaining the coercive force Hc of the ε-iron oxide portion alone at a large value in order to ensure thermal stability.

The ε-iron oxide particle may contain an additive instead of the structure of the composite particles described above, or may have the structure of the composite particles and may contain an additive as well. In this case, a part of Fe of the ε-iron oxide particle is substituted with the additive. The coercive force Hc of all the ε-iron oxide particles can be adjusted to the coercive force Hc suitable for recording also when the ε-iron oxide particle includes the additive, such that recordability can be improved. The additive is a metal element other than iron, preferably a trivalent metal element, more preferably at least one selected from the group consisting of Al, Ga, and In, and even more preferably at least one selected from the group consisting of Al and Ga.

Specifically, the ε-iron oxide particle containing an additive is an ε-Fe₂₋ₓMₓO₃ crystal (here, M is a metal element other than iron, preferably a trivalent metal element, and more preferably one or more selected from the group consisting of Al, Ga, and In, and x is, for example, 0<x<1).

The average particle size (average maximum particle size) of the magnetic powder is preferably 22 nm or less, more preferably 8 nm or more and 22 nm or less, and even more preferably 12 nm or more and 22 nm or less. In the magnetic recording medium 10, a region having a size of ½ of a recording wavelength is an actual magnetization region. For this reason, an excellent SNR can be obtained by setting the average particle size of the magnetic powder to half or less of the shortest recording wavelength. Therefore, if the average particle size of the magnetic powder is 22 nm or less, an excellent electromagnetic conversion characteristic (for example, SNR) can be obtained in the magnetic recording medium 10 having a high recording density (for example, the magnetic recording medium 10 configured to be capable of recording a signal at the shortest recording wavelength of 44 nm or less). Meanwhile, if the average particle size of the magnetic powder is 8 nm or more, the dispersibility of the magnetic powder is further improved, and a more excellent electromagnetic conversion characteristic (for example, SNR) can be obtained.

The average aspect ratio of the magnetic powder is preferably 1.0 or more and 3.0 or less, more preferably 1.0 or more and 2.9 or less, and even more preferably 1.0 or more and 2.5 or less. If the average aspect ratio of the magnetic powder is in the above-described numerical range, aggregation of the magnetic powder can be suppressed, and when the magnetic powder is vertically oriented in a step of forming the magnetic layer 13, resistance applied to the magnetic powder can be suppressed. Therefore, the vertical orientation of the magnetic powder can be improved.

In a case where the magnetic powder contain ε-iron oxide particles, the average particle size and the average aspect ratio of the magnetic powder are determined as follows. First, as described regarding a case where the magnetic powder includes a hexagonal ferrite particle powder, a magnetic recording medium to be measured is cut out. The magnetic recording medium to be measured is processed with a focused ion beam (FIB) method and the like to perform thinning. In a case where the FIB method is used, formation of a carbon film and a tungsten thin film as protective films is performed as pre-processing for observing a TEM image of a cross section described below. The carbon film is formed on a magnetic layer side surface and a back layer side surface of the magnetic recording medium with a vapor deposition method, and then the tungsten thin film is further formed on the magnetic layer side surface with a vapor deposition method or a sputtering method. The thinning is performed in the length direction (longitudinal direction) of the magnetic recording medium. That is, the thinning is performed to form a cross section parallel to both the longitudinal direction and the thickness direction of the magnetic recording medium.

Using a transmission electron microscope (H-9500 manufactured by Hitachi High-Technologies Corporation), the above-described cross section of the obtained thin piece sample is observed at an acceleration voltage of 200 kV and a total magnification of 500,000 times so that the entire magnetic layer 13 is included in the thickness direction of the magnetic layer 13, and a TEM photo is imaged.

Next, 50 particles whose shapes can be clearly recognized are selected from the imaged TEM photo, and a long axis length DL and a short axis length DS of each particle are measured. Here, the long axis length DL means the largest one of the distances between two parallel lines drawn from all angles so as to be in contact with the outline of each particle (so-called maximum Feret diameter). Meanwhile, the short axis length DS means the largest one of the lengths of a particle in a direction orthogonal to the long axis (DL) of the particle.

Subsequently, the measured long axis lengths DL of the 50 particles are simply averaged (arithmetically averaged) to determine the average long axis length DLₐᵥₑ. The average long axis length DLₐᵥₑ determined in this manner is regarded as the average particle size of the magnetic powder. Furthermore, the measured short axis lengths DS of the 50 particles are simply averaged (arithmetically averaged) to determine the average short axis length DSₐᵥₑ. Then, the average aspect ratio (DLₐᵥₑ/DSₐᵥₑ) of the particles is determined from the average long axis length DLₐᵥₑ and the average short axis length DSₐᵥₑ.

The average particle volume of the magnetic powder may be preferably 1600 nm³ or less, more preferably 1500 nm³ or less, more preferably 1400 nm³ or less, and even more preferably 1200 mm³ or less, 1100 nm³ or less, or 1000 nm³ or less. The average particle volume of the magnetic powder can be preferably 500 nm³ or more, and more preferably 700 nm³ or more.

In a case where the average particle volume of the magnetic powder is the above-described upper limit or less (for example, 1600 nm³ or less), an excellent electromagnetic conversion characteristic (for example, SNR) can be obtained in the magnetic recording medium 10 having a high recording density. In a case where the average particle volume of the magnetic powder is the above-described lower limit or more (for example, 500 nm³ or more), the dispersibility of the magnetic powder is further improved, and a more excellent electromagnetic conversion characteristic (for example, SNR) can be obtained.

In a case where the ε-iron oxide particles have a spherical shape or a substantially spherical shape, the average particle volume of the magnetic powder is determined as follows. First, the average long axis length DLₐᵥₑ is determined in a manner similar to the above-described method of calculating the average particle size of the magnetic powder. Next, the average particle volume V of the magnetic powder is determined with the following formula.

$$V = ( Π / 6 ) \times {DL}_{ave}^{3}$$

In a case where the ε-iron oxide particles have a cubic shape, the average particle volume of the magnetic powder is determined as follows. The magnetic recording medium 10 is processed with a focused ion beam (FIB) method and the like to perform thinning. In a case where the FIB method is used, formation of a carbon film and a tungsten thin film as protective films is performed as pre-processing for observing a TEM image of a cross section described below. The carbon film is formed on a magnetic layer side surface and a back layer side surface of the magnetic recording medium 10 with a vapor deposition method, and then the tungsten thin film is further formed on the magnetic layer side surface with a vapor deposition method or a sputtering method. The thinning is performed in the length direction (longitudinal direction) of the magnetic recording medium 10. That is, the thinning is performed to form a cross section parallel to both the longitudinal direction and the thickness direction of the magnetic recording medium 10.

Using a transmission electron microscope (H-9500 manufactured by Hitachi High-Technologies Corporation), a cross section of the obtained thin piece sample is observed at an acceleration voltage of 200 kV and a total magnification of 500,000 times so that the entire magnetic layer 13 is included in the thickness direction of the magnetic layer 13, and a TEM photo is obtained. Note that the magnification and the acceleration voltage may be appropriately adjusted according to the type of the apparatus.

Next, 50 particles whose shapes can be clearly identified are selected from the imaged TEM photo, and the side length DC of each particle is measured. Subsequently, the measured side lengths DC of the 50 particles are simply averaged (arithmetically averaged) to determine the average side length DCₐᵥₑ. Next, the average particle volume Vₐᵥₑ of the magnetic powder (particle volume) is determined from the following formula using the average side length DCₐᵥₑ.

$${V}_{ave} = {DC}_{ave}^{3}$$

The coercive force Hc of the ε-iron oxide particles is preferably 2500 Oe or more, and more preferably 2800 Oe or more and 4200 e or less.

### (Embodiment in Which Magnetic Powder Contains Co-Containing Spinel Ferrite)

According to still another preferred embodiment of the present technology, the magnetic powder can include a powder of nanoparticles containing Co-containing spinel ferrite (hereinafter, also referred to as “cobalt ferrite particles”). That is, the magnetic powder can be a cobalt ferrite magnetic powder. The cobalt ferrite particles preferably have uniaxial crystal anisotropy. The cobalt ferrite magnetic particles have, for example, a cubic shape or a substantially cubic shape. The Co-containing spinel ferrite may further contain one or more selected from the group consisting of Ni, Mn, Al, Cu, and Zn in addition to Co.

The cobalt ferrite has, for example, an average composition represented by the following formula.

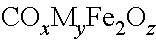

Here, in the formula, M is, for example, one or more metals selected from the group consisting of Ni, Mn, Al, Cu, and Zn, x is a value within a range of 0.4≤x≤1.0, y is a value within a range of 0≤y≤0.3, where x and y satisfy a relationship of (x+y)≤1.0, z is a value within a range of 3≤z≤4, and a part of Fe may be substituted with another metal element.

The average particle size of the cobalt ferrite magnetic powder is preferably 21 nm or less, and more preferably 19 nm or less. The coercive force Hc of the cobalt ferrite magnetic powder is preferably 2500 Oe or more, and more preferably 2600 Oe or more and 3500 Oe or less.

In a case where the magnetic powder includes a powder of cobalt ferrite particles, the average particle size of the magnetic powder is preferably 25 nm or less, and more preferably 10 nm or more and 19 nm or less. If the average particle size of the magnetic powder is as small as described above, an excellent electromagnetic conversion characteristic (for example, SNR) can be obtained in the magnetic recording medium 10 having a high recording density. Meanwhile, if the average particle size of the magnetic powder is 10 nm or more, the dispersibility of the magnetic powder is further improved, and a more excellent electromagnetic conversion characteristic (for example, SNR) can be obtained. In a case where the magnetic powder includes a powder of cobalt ferrite particles, the average aspect ratio and the average particle size of the magnetic powder are determined with the same method as in a case where the magnetic powder contains ε-iron oxide particles.

The average particle volume of the magnetic powder may be preferably 1600 nm³ or less, more preferably 1500 nm³ or less, more preferably 1400 nm³ or less, and even more preferably 1200 nm³ or less, 1100 nm³ or less, or 1000 nm³ or less. The average particle volume of the magnetic powder can be preferably 500 nm³ or more, and more preferably 700 nm³ or more.

In a case where the average particle volume of the magnetic powder is the above-described upper limit or less (for example, 1600 nm³ or less), an excellent electromagnetic conversion characteristic (for example, SNR) can be obtained in the magnetic recording medium 10 having a high recording density. In a case where the average particle volume of the magnetic powder is the above-described lower limit or more (for example, 500 nm³ or more), the dispersibility of the magnetic powder is further improved, and a more excellent electromagnetic conversion characteristic (for example, SNR) can be obtained.

### (Binder)

As the binder, a resin having a structure in which a crosslinking reaction is imparted to a polyurethane-based resin, a vinyl chloride-based resin, or the like is preferable. However, the binder is not limited thereto, and other resins may be appropriately blended according to a physical property and the like required for the magnetic recording medium 10. The resin to be blended is not particularly limited usually as long as it is generally used in a coating type magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, or nitrocellulose), a styrene-butadiene copolymer, a polyester resin, an amino resin, synthetic rubber, and the like.

Furthermore, as the binder, a thermosetting resin or a reactive resin may be used, and examples thereof include a phenol resin, an epoxy resin, a urea resin, a melamine resin, an alkyd resin, a silicone resin, a polyamine resin, a urea-formaldehyde resin, and the like.

Furthermore, a polar functional group such as —SO₃M, —OSO₃M, —COOM, P═O(OM)₂, or the like may be introduced into each binding agent described above in order to improve the dispersibility of the magnetic powder. Here, in the formula, M is a hydrogen atom or an alkali metal such as lithium, potassium, sodium, or the like.

Moreover, examples of the polar functional group include a side chain type having an end group of —NR1R2 or —NR1R2R3⁺X⁻ and a main chain type of >NR1R2⁺X⁻. Here, in the formulae, each of R1, R2, and R3 is a hydrogen atom or a hydrocarbon group, and X⁻ is an ion of a halogen element such as fluorine, chlorine, bromine, iodine, or the like, or an inorganic or organic ion. Furthermore, examples of the polar functional group include —OH, —SH, —CN, an epoxy group, and the like.

In an embodiment of the present technology, the magnetic layer contains a binder containing a chlorine atom (Cl). The binder containing a chlorine atom may be a resin containing a chlorine atom (Cl) (hereinafter, referred to as a “chlorine-containing resin”). The chlorine-containing resin is a resin containing a chlorine atom as at least one of elements included in the resin.

The chlorine-containing binder is, for example, a vinyl chloride-based resin. More specific examples of the chlorine-containing binder include polyvinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a vinylidene chloride-acrylonitrile copolymer, synthetic rubber, and the like.

The content of the chlorine-containing binder in the magnetic layer may be, for example, preferably 30 parts by mass or more, more preferably 35 parts by mass or more, and still more preferably 40 parts by mass or more with respect to 100 parts by mass of the magnetic powder. Furthermore, the content may be, for example, preferably 70 parts by mass or less, more preferably 65 parts by mass or less, and still more preferably 60 parts by mass or less with respect to 100 parts by mass of the magnetic powder.

The magnetic layer may further contain a chlorine-free binder in addition to the chlorine-containing binder. The chlorine-free binder may be a chlorine-free resin. The chlorine-free resin may be, for example, a binder containing a nitrogen atom (N). Examples of the binder containing such a nitrogen atom (N) include polyurethane-based resins. The polyurethane-based resin is a polymer having a urethane bond (—NH—C(═O)—), and may be manufactured by, for example, a polyaddition reaction between an isocyanate compound and a diol compound. The polyurethane-based resin may be, for example, a urethane-modified copolyester. The urethane-modified copolyester may be a urethane-modified copolyester having a basic skeleton of an aromatic polyester and having a side chain containing a urethane component, or a urethane-modified copolyester having a basic skeleton including a repeating unit of an ester and a repeating unit of a urethane.

The content of the chlorine-free binder in the magnetic layer may be, for example, preferably 1 part by mass or more, more preferably 2 parts by mass or more, and still more preferably 3 parts by mass or more with respect to 100 parts by mass of the magnetic powder. Furthermore, the content may be, for example, preferably 10 parts by mass or less, more preferably 9 parts by mass or less, and still more preferably 8 parts by mass or less with respect to 100 parts by mass of the magnetic powder.

### (Lubricant)

The magnetic layer can contain a lubricant. The lubricant may be, for example, one or two or more selected from fatty acids and/or fatty acid esters, and can preferably contain both a fatty acid and a fatty acid ester. The fatty acid may be preferably a compound represented by the general chemical formula (1) or the general chemical formula (2) described below. For example, one or both of a compound represented by the general chemical formula (1) and a compound represented by the general chemical formula (2) described below may be contained as the fatty acid.

Furthermore, the fatty acid ester may be preferably a compound represented by the general chemical formula (3) or the general chemical formula (4) or the general chemical formula (5) described below. For example, as the fatty acid ester, any one of a compound represented by the general chemical formula (3) described below and compounds represented by the general chemical formula (4) and the general chemical formula (5) may be contained, or two or more compounds selected from these compounds may be contained.

When the lubricant contains any one or both of the compound represented by the general chemical formula (1) and the compound represented by the general chemical formula (2), and any one or two or more selected from of the compound represented by the general chemical formula (3), the compound represented by the general chemical formula (4), and the general chemical formula (5), an increase in dynamic frictional coefficient due to repeated recording or reproducing on the magnetic recording medium can be suppressed.

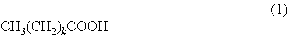

Here, in the general chemical formula (1), k is an integer selected from a range of 14 or more and 22 or less, and more preferably a range of 14 or more and 18 or less.

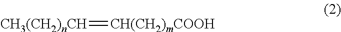

Here, in the general chemical formula (2), the sum of n and m is an integer selected from a range of 12 or more and 20 or less, and more preferably a range of 14 or more and 18 or less.

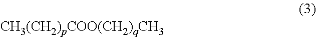

Here, in the general chemical formula (3), p is an integer selected from a range of 14 or more and 22 or less, and more preferably a range of 14 or more and 18 or less, and q is an integer selected from a range of 2 or more and 5 or less, and more preferably a range of 2 or more and 4 or less.

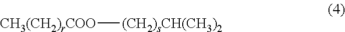

Here, in the general chemical formula (4), r is an integer selected from a range of 14 or more and 22 or less, and s is an integer selected from a range of 1 or more and 3 or less.

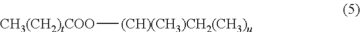

Here, in the general formula (5), t is an integer selected from a range of 14 or more and 22 or less, and u is an integer selected from a range of 1 or more and 3 or less.

Examples of the lubricant include esters of a monobasic fatty acid having 10 to 24 carbon atoms and any of monohydric to hexahydric alcohols having 2 to 12 carbon atoms, mixed esters thereof, di-fatty acid esters, and tri-fatty acid esters, and the like. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, octyl myristate, and the like. The magnetic layer may include one or two or more of these.

The content of the lubricant may be, for example, preferably 1 part by mass or more, and more preferably 2 parts by mass or more with respect to 100 parts by mass of the magnetic powder. Furthermore, the content may be, for example, preferably 10 parts by mass or less, more preferably 8 parts by mass or less, and still more preferably 6 parts by mass or less with respect to 100 parts by mass of the magnetic powder.

### (Additive)

The magnetic layer 13 may further contain aluminum oxide (α, β, or γ-alumina), chromium oxide, silicon oxide, diamond, garnet, emery, boron nitride, titanium carbide, silicon carbide, titanium carbide, titanium oxide (rutile type or anatase type titanium oxide), or the like, as non-magnetic reinforcing particles.

In an embodiment of the present technology, the magnetic layer may contain first particles having conductivity and second particles having a Mohs hardness of 7 or more. The first particles and the second particles may form protrusions on the magnetic layer side surface. For example, the first particles can prevent an increase in frictional force during traveling of the magnetic recording tape, and for example, exhibit a function as a solid lubricant component. Furthermore, the second particles can exhibit a polishing effect (further, an anchor effect) for cleaning the magnetic head. It is conceivable to contain these two components in a magnetic layer of a magnetic recording tape to improve the traveling performance by preventing an increase in frictional force and cleaning the magnetic head.

The first particles have conductivity. As the first particles, fine particles can be used that contain carbon as a main component, and the fine particles may be, for example, preferably carbon particles. Examples of such carbon particles include carbon black. As the carbon black, for example, Asahi #15 and #15HS manufactured by Asahi Carbon Co., Ltd., SEAST TA manufactured by TOKAI CARBON CO., LTD., and the like can be used. Furthermore, hybrid carbon may be used in which carbon is attached to a silica particle surface.

The average particle size (arithmetic average of particle diameters measured using electron microscopy) of the first particles (in particular, carbon particles such as carbon black) may be, for example, preferably 15 nm or more, more preferably 30 nm or more, and still more preferably 50 nm or more. Furthermore, the average particle size may be, for example, preferably 200 nm or less, more preferably 180 nm or less, still more preferably 150 nm or less, 130 nm or less, or 120 nm or less. The numerical range of the average particle size may be appropriately selected from these upper limits and lower limits, and may be, for example, preferably 50 nm to 200 nm, more preferably 50 nm to 180 nm, still more preferably 50 nm to 150 nm, and even more preferably 50 nm to 130 nm.

The nitrogen adsorption specific surface area of the first particles (in particular, carbon particles such as carbon black) may be, for example, preferably 5 m²/g to 50 m²/g, and is more preferably 7 m²/g to 50 m²/g, still more preferably 10 m²/g to 50 m²/g, and even more preferably 12 m²/g to 50 m²/g.

The iodine adsorption amount of the first particles (in particular carbon particles, for example carbon black) may be, for example, preferably 5 mg/g to 50 mg/g, more preferably 7 mg/g to 50 mg/g, still more preferably 10 mg/g to 50 mg/g, and even more preferably 12 mg/g to 50 mg/g.

From the viewpoint of suppressing deformation due to contact with the magnetic head, the second particle may have a Mohs hardness of preferably 7 or more, more preferably 7.5 or more, still more preferably 8 or more, and even more preferably 8.5 or more. From the viewpoint of suppressing head wear, the Mohs hardness of the second particles may be, for example, preferably 10 or less, and more preferably 9.5 or less. That is, the second particles may include a material having such a Mohs hardness.

The second particles may be preferably inorganic particles. The second particles may be, for example, α-alumina (the α transformation rate may be, for example, 90% or more), β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by subjecting a raw material of magnetic iron oxide to dehydration and annealing treatment, a product obtained by subjecting the above-described acicular α-iron oxide to surface treatment with aluminum and/or silica as necessary, diamond powder, or a combination of two or more thereof. As the second particles, alumina particles such as α-alumina, β-alumina, γ-alumina, and the like, and silicon carbide are preferably used. These second particles may have any shape such as a needle shape, a spherical shape, a dice shape, and the like, and preferably have a shape including a corner part because, for example, such particles have high abrasivity.

The average particle size (for example, arithmetic average of particle diameters measured using electron microscopy) of the second particles (in particular, inorganic particles such as alumina) may be, for example, preferably 15 nm or more, more preferably 30 nm or more, and still more preferably 50 nm or more. Furthermore, the average particle size may be, for example, preferably 200 nm or less, more preferably 180 nm or less, still more preferably 150 nm or less, 130 nm or less, or 120 nm or less. The numerical range of the average particle size may be appropriately selected from these upper limit and lower limit, and is, for example, preferably 50 nm to 180 nm, more preferably 60 nm to 150 nm, and still more preferably 60 nm to 120 nm.

The second particles (in particular, inorganic particles such as alumina) may have no conductivity. That is, the second particles may be not particles having conductivity like that of the first particles.

### (Underlayer)

The underlayer 12 is a non-magnetic layer containing a non-magnetic powder and a binder as main components. The underlayer 12 may further contain at least one additive of another particle, a lubricant, a curing agent, a corrosion inhibitor, or the like, as needed.

### (Non-Magnetic Powder)

The non-magnetic powder contained in the underlayer 12 contains, for example, at least one kind of particles selected from inorganic particles and organic particles, and particularly contains at least one kind of particles selected from inorganic particles. One kind of non-magnetic powder may be used alone, or two or more kinds of non-magnetic powders may be used in combination. The non-magnetic inorganic particles may include, for example, one or a combination of two or more selected from metals, metal oxides, metal carbonates, metal sulfates, metal nitrides, metal carbides, and metal sulfides. More specifically, the inorganic particles may be, for example, one or two or more selected from iron oxide, aluminum oxide, carbon black, iron oxyhydroxide, hematite, titanium oxide, silicon oxide, titanium carbide, silicon carbide, diamond, and calcium carbonate. Examples of a shape of the non-magnetic powder include various shapes such as a needle shape, a spherical shape, a cubic shape, a plate shape, and the like, but are not particularly limited thereto.

In an embodiment of the present technology, the non-magnetic powder contains at least iron oxide, particularly acicular iron oxide. In this embodiment, the non-magnetic powder may further contain carbon black and/or aluminum oxide.

The average long axis length of iron oxide (particularly, acicular iron oxide) may be, for example, preferably 0.01 μm or more, more preferably 0.04 μm or more, and still more preferably 0.07 μm or more. Furthermore, the average long axis length may be, for example, preferably 0.5 μm or less, more preferably 0.4 μm or less, and still more preferably 0.3 μm or less.

The average particle diameter of the carbon black may be, for example, preferably 10 nm or more, more preferably 12 nm or more, and still more preferably 15 nm or more. Furthermore, the average particle diameter of the carbon black may be, for example, preferably 250 nm or less, more preferably 150 nm or less, and still more preferably 100 nm or less.

The content of the carbon black may be, for example, preferably 15 parts by mass or more, more preferably 20 parts by mass or more, and still more preferably 25 parts by mass or more with respect to 100 parts by mass of the iron oxide. Furthermore, the content of carbon black may be, for example, preferably 45 parts by mass or less, more preferably 40 parts by mass or less, and still more preferably 35 parts by mass or less with respect to 100 parts by mass of the iron oxide.

The average particle diameter of the aluminum oxide may be, for example, preferably 30 nm or more, more preferably 40 nm or more, and still more preferably 60 nm or more. Furthermore, the average particle diameter of the aluminum oxide may be, for example, preferably 180 nm or less, more preferably 150 nm or less, and still more preferably 120 nm or less.

The content of the aluminum oxide may be, for example, preferably 1 part by mass or more, more preferably 2 parts by mass or more, and still more preferably 3 parts by mass or more with respect to 100 parts by mass of the iron oxide. Furthermore, the content of the aluminum oxide may be, for example, preferably 10 parts by mass or less, more preferably 9 parts by mass or less, and still more preferably 8 parts by mass or less with respect to 100 parts by mass of the iron oxide.

### (Binder)

The underlayer contains a binder. The description regarding the binder contained in the magnetic layer 13 also applies to the binder contained in the underlayer 12.

In the present technology, the underlayer contains at least a chlorine-containing binder. The chlorine-containing binder may be a chlorine-containing resin. The chlorine-containing resin is a resin containing a chlorine atom as at least one of elements included in the resin.

The chlorine-containing binder is, for example, a vinyl chloride-based resin. More specific examples of the chlorine-containing binder include polyvinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a vinylidene chloride-acrylonitrile copolymer, synthetic rubber, and the like.

The underlayer contains a chlorine-containing binder adsorbed to the non-magnetic powder and a chlorine-containing binder not adsorbed to the non-magnetic powder. The distribution state of the chlorine-containing binder not adsorbed to the non-magnetic powder in the underlayer is affected by the solvent contained in the coating material for forming a magnetic layer and the coating material drying treatment in the step of forming a magnetic layer in the manufacturing process of the magnetic recording medium. The reliability of the magnetic recording medium can be enhanced by controlling the distribution state according to the present technology.

The volume of the chlorine-containing binder contained in the underlayer may be, for example, an amount corresponding to 20 vol % or more, preferably 30 vol % or more, and more preferably 40 vol % or more of the volume of the non-magnetic powder (particularly, the total volume of the non-magnetic powder). Furthermore, the volume may be, for example, an amount corresponding to 180 vol % or less, preferably 170 vol % or less, and more preferably 160 vol % or less of the volume of the non-magnetic powder (particularly, the total volume of the non-magnetic powder).

For example, if the total volume of the non-magnetic powder is 100, the volume of the chlorine-containing binder in the underlayer may be, for example, preferably 20 to 180, more preferably 30 to 170, and still more preferably 40 to 160.

In an embodiment, the underlayer contains iron oxide as the non-magnetic powder. In this embodiment, the content of the chlorine-containing binder in the underlayer may be, for example, preferably 20 parts by mass or more, more preferably 25 parts by mass or more, and still more preferably 30 parts by mass or more with respect to 100 parts by mass of the iron oxide. Furthermore, the content may be, for example, preferably 70 parts by mass or less, more preferably 65 parts by mass or less, and still more preferably 60 parts by mass or less with respect to 100 parts by mass of the iron oxide.

The underlayer may further contain a chlorine-free binder in addition to the chlorine-containing binder. The chlorine-free binder may be a chlorine-free resin. The chlorine-free resin may be, for example, a resin containing a nitrogen atom (N). Examples of the resin containing such a nitrogen atom (N) include polyurethane-based resins. The polyurethane-based resin is a polymer having a urethane bond (—NH—C(═O)—), and may be manufactured by, for example, a polyaddition reaction between an isocyanate compound and a diol compound. The polyurethane-based resin may be, for example, a urethane-modified copolyester. The urethane-modified copolyester may be a urethane-modified copolyester having a basic skeleton of an aromatic polyester and having a side chain containing a urethane component, or a urethane-modified copolyester having a basic skeleton including a repeating unit of an ester and a repeating unit of a urethane.

The volume of the chlorine-free binder contained in the underlayer may be, for example, an amount corresponding to 0 vol % or more, preferably 10 vol % or more, and more preferably 20 vol % or more of the volume of the non-magnetic powder (particularly, the total volume of the non-magnetic powder). Furthermore, the volume may be, for example, an amount corresponding to 150 vol % or less, preferably 140 vol % or less, and more preferably 130 vol % or less of the volume of the non-magnetic powder (particularly, the total volume of the non-magnetic powder). Note that the underlayer may be free of the chlorine-free binder.

For example, if the total volume of the non-magnetic powder is 100, the volume of the chlorine-containing binder in the underlayer may be, for example, preferably 0 to 150, more preferably 10 to 140, and still more preferably 200 to 130.

In an embodiment, the underlayer contains iron oxide as the non-magnetic powder. In this embodiment, the content of the chlorine-free binder in the underlayer may be, for example, preferably 0 parts by mass or more, more preferably 5 parts by mass or more, and still more preferably 10 parts by mass or more with respect to 100 parts by mass of the iron oxide. Furthermore, the content may be, for example, preferably 30 parts by mass or less, more preferably 25 parts by mass or less, and still more preferably 20 parts by mass or less with respect to 100 parts by mass of the iron oxide.

### (Lubricant)

The underlayer can contain a lubricant. The lubricant may be, for example, one or two or more selected from fatty acids and/or fatty acid esters, and the lubricant may be preferably a compound represented by the general chemical formula (1) or the general chemical formula (2), or the general chemical formula (3) or the general chemical formula (4) described above for the magnetic layer. One or a plurality of these compounds may be contained.

Examples of the lubricant include esters of a monobasic fatty acid having 10 to 24 carbon atoms and any of monohydric to hexahydric alcohols having 2 to 12 carbon atoms, mixed esters thereof, di-fatty acid esters, and tri-fatty acid esters, and the like. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, octyl myristate, and the like. The magnetic layer may include one or two or more of these.

The content of the lubricant in the underlayer may be, for example, preferably 1 part by mass or more, more preferably 1.5 parts by mass or more, and still more preferably 2 parts by mass or more with respect to 100 parts by mass of the nonmagnetic powder (100 parts by mass of the total amount of the non-magnetic powder). Furthermore, the content may be, for example, preferably 12 parts by mass or less, more preferably 10 parts by mass or less, and still more preferably 8 parts by mass or less with respect to 100 parts by mass of the non-magnetic powder (100 parts by mass of the total amount of the non-magnetic powder). The above-described numerical ranges may be applied, for example, in a case where the non-magnetic powder contains iron oxide.

In an embodiment, the underlayer contains iron oxide as the non-magnetic powder. In this embodiment, the content of the lubricant in the underlayer may be, for example, preferably 2 parts by mass or more, more preferably 2.5 parts by mass or more, and still more preferably 3 parts by mass or more with respect to 100 parts by mass of the iron oxide. Furthermore, the content may be, for example, preferably 8 parts by mass or less, more preferably 7 parts by mass or less, and still more preferably 6 parts by mass or less with respect to 100 parts by mass of the iron oxide.

### (Back Layer)

The back layer 14 can contain a binding agent and a non-magnetic powder. The back layer 14 may contain various additives such as a lubricant, a curing agent, an antistatic agent, and the like, as needed. The descriptions regarding the binding agent and the non-magnetic powder contained in the above-described non-magnetic layer 12 also apply to the binding agent and the non-magnetic powder contained in the back layer 14.

The average particle size of the inorganic particles contained in the back layer 14 is preferably 10 nm or more and 150 nm or less, and more preferably 15 nm or more and 110 nm or less. The average particle size of the inorganic particles is determined in a manner similar to that for determination of the average particle size D of the magnetic powder described above.

### (3) Physical Properties and Structure

### (Cl/Fe Atomic Ratio α, N/Fe Atomic Ratio β, (Cl+N)/Fe Atomic Ratio γ)

The Cl/Fe atomic ratio α of the surface of the magnetic layer 13 of the magnetic recording medium 10 measured by the X-ray photoelectron spectrometer (XPS apparatus) may be 0.60 or more and 5.70 or less, and preferably 0.65 or more and 5.70 or less. Note that the above value is a value in a case where the surface of the magnetic layer is not surface-treated. Examples of the surface treatment of the magnetic layer surface include a treatment of removing impurities on the magnetic layer surface, for example, with a wrapping tape or a nonwoven fabric. In a case where such a magnetic layer surface is subjected to surface treatment, the amount of the binder on the magnetic layer surface may be small, and each of the lower limit and the upper limit of the atomic ratio range described above may be reduced by 0.0375, specifically, the Cl/Fe atomic ratio α of the surface of the surface-treated magnetic layer 13 may be 0.56 or more and 5.66 or less, and preferably 0.61 or more and 5.66 or less. Furthermore, the N/Fe atomic ratio β of the surface of the magnetic layer 13 of the magnetic recording medium 10 measured by the X-ray photoelectron spectrometer (XPS apparatus) may be 0.16 or more and 0.98 or less. As for the N/Fe atomic ratio β, in a case where the magnetic layer surface is surface-treated in the similar manner described above, each of the lower limit and the upper limit of the atomic ratio range may be reduced by 0.0207, specifically, the N/Fe atomic ratio α of the surface of the magnetic layer 13 subjected to the surface treatment may be 0.14 or more and 0.96 or less. Moreover, the (Cl+N)/Fe atomic ratio γ of the surface of the magnetic layer 13 of the magnetic recording medium 10 measured by the X-ray photoelectron spectrometer (XPS apparatus) may be 0.60 or more and 6.69 or less. As for the (Cl+N)/Fe atomic ratio γ, in a case where the surface of the magnetic layer is surface-treated in the similar manner described above, each of the lower limit and the upper limit of the atomic ratio range may be reduced by 0.0582, specifically, the (Cl+N)/Fe atomic ratio α of the surface of the surface-treated magnetic layer 13 may be 0.54 or more and 6.63 or less. The method for measuring the atomic ratio is as follows.

### (Method of Producing Sample)

In a tape-shaped magnetic recording medium accommodated in a magnetic recording cartridge, a part 20 m from the outermost side in the tape longitudinal direction is used for producing a sample. For example, a magnetic tape T accommodated in a cartridge such as the cartridge 10A described below is unwound, and a part at a position about 20 m from a connection portion 221 between the magnetic tape T and the leader tape LT in the longitudinal direction is used for producing a sample. Among these parts, a substantially central part in the width direction of the magnetic tape T is cut into an appropriate size (for example, a quadrangle of about 8 mmx about 8 mm) for preparing a sample for XPS measurement.

A sample for XPS measurement is prepared as described above. Note that the sample for XPS measurement is not washed with hexane for the purpose of removing the lubricant component present on the surface in order to avoid a decrease in the abundance of the binder present on the surface.

### (Measurement Method of Sample)

The sample for XPS measurement is measured by an XPS apparatus. The measurement is performed according to the following procedure.
(i) The sample for XPS measurement is attached to a Q 6 mm XPS (X-ray photoelectron spectrometer) sample stand, and fixed using a carbon tape. Note that the excess sample is cut with scissors so that the sample size is Φ 6 mm.
(ii) The sample for XPS measurement is set in a preparation room of the XPS apparatus, and preliminary evacuation is performed for 5 minutes. (iii) The sample for XPS measurement is conveyed to the main chamber of the XPS apparatus, and main evacuation is performed. In a case where a plurality of samples is measured, the procedures (i) to (iii) are repeated.
(iv) Main evacuation is performed until the degree of vacuum in the main chamber becomes 2.0×10⁻⁶ Pa or less.
(v) The output of the Emmission and the output of the Accel High Voltage are increased stepwise, and when the output reaches a maximum of 20 mA and 20 kV, respectively, waiting is performed for 5 minutes for stabilization and degassing of the X-ray gun. At the time of standby, the position of the sample for XPS measurement is changed so that the irradiation position of the X-ray gun becomes a dummy sample or a blank so that the sample for XPS measurement is not irradiated with the X-ray.
(vi) Although the degree of vacuum may deteriorate due to aging, waiting is performed until the degree of vacuum becomes 2.0×10⁻⁶ Pa or less.
(vii) First, the chlorine (Cl) element is measured, and then the nitrogen (N) element, the iron (Fe) element, and the carbon (C) element are measured in this order. The measurement conditions for each element are shown in Table 1 below.

TABLE 1

| Measurement | | Emission | Accel High Voltage | Center | Width | Step | Dwell | Number |
|---|---|---|---|---|---|---|---|---|
| spectrum | X-ray | [mA] | [kV] | [eV] | [eV] | [eV] | [ms] | of Scans |
| Cl 2p | Mg Kα | 15 | 10 | 200 | 20.1 | 0.1 | 458 | 3 |
| N 1s | Mg Ka | 15 | 10 | 400 | 20.1 | 0.1 | 157.5 | 10 |
| Fe 2p 3/2 | Mg Kα | 15 | 10 | 721 | 38.1 | 0.1 | 298.5 | 10 |

As the number of scans in the XPS measurement increases, the measurement variation decreases. However, as for the chlorine (Cl) element, when the number of scans increases, a dehydrochlorination reaction occurs due to the influence of heat at the time of X-ray irradiation, and it is expected that the detection intensity decreases. FIG. 3 is a graph showing the relationship between the number of scans in Cl measurement and the Cl 2p integrated intensity. In FIG. 3, series 1 indicates the integrated intensity at each number of scans.

As shown in FIG. 3, it is found that the Cl 2p integrated intensity decreases in a case where the number of scans is 6 or more, and the number of scans for Cl is set to 3.

Furthermore, when Cl is measured after measurement for elements other than Cl, the detection intensity of Cl is expected to decrease for the same reason as described above. Therefore, in the procedure (vi) described above, first, the chlorine (Cl) element is measured, and then the nitrogen (N) element, the iron (Fe) element, and the carbon (C) element are measured in this order.

(vii) The peak intensity of each peak area is determined from the obtained spectrum of each element. FIG. 4 is a graph showing a relationship between a measurement spectrum of Cl and a peak intensity. As shown in FIG. 4, the peak area is integrated from the Cl spectrum to determine the peak intensity. Note that the measurement spectrum may be shifted due to charge-up, but the determination is made on the basis of whether the peak of the carbon (C) element is shifted from 285 eV. In a case where the shift has been made, the shift is corrected from the measurement spectra of all the elements.

(viii) The atomic ratio is obtained by the following formula using the resolution sensitivity factor (RSF) value of each element.

$$Cl / Fe atomic ratio α = ( Cl integrated intensity / RSF value of Cl ) \text{} / ( Fe integrated intensity / RSF value of Fe ) \\ N / Fe atomic ratio β = ( N integrated intensity / RSF value of N ) \text{} / ( Fe integrated intensity / RSF value of Fe )$$

$$( Cl + N ) / Fe atomic ratio γ = ( Cl integrated intensity + N integrated intensity ) \text{} / ( RSF value of Cl + RSF value of N ) / ( Fe integrated intensity / RSF value of Fe )$$

Note that the RSF value is a value unique to the XPS apparatus, and the RSF value in the XPS apparatus used is as follows.
RSF value of Cl: 2.36
RSF value of N: 1.77
RSF value of Fe: 15.97

### (Average Thickness (Average Total Thickness) t_{T} of Magnetic Recording Medium)

The average thickness tr of the magnetic recording medium 10 (hereinafter, also referred to as the magnetic tape T) is determined as follows. First, for example, a magnetic tape T accommodated in a cartridge such as the cartridge 10A described below is unwound, and the magnetic tape T is cut out into a length of 250 mm at a position 30 m from a connection portion 221 between the magnetic tape T and a leader tape LT in the longitudinal direction to prepare a sample. Next, the thickness of the sample is measured at five positions using a laser hologauge (LGH-110C) manufactured by Mitutoyo Corporation as a measuring device, and these measured values are simply averaged (arithmetically averaged) to calculate the average thickness t_{T} [μm]. Note that the five measurement positions are randomly selected from the sample so as to be different positions in the longitudinal direction of the magnetic tape T.

### (Average Thickness of Underlayer (Non-Magnetic Layer))

The average thickness of the underlayer 12 can be determined as follows. First, for example, a magnetic tape T accommodated in a cartridge such as the cartridge 10A described below is unwound, and the magnetic tape T is cut out into a length of 250 mm at each of three positions 10 m, 30 m, and 50 m, respectively, from a connection portion 221 between the magnetic tape T and a leader tape LT in the longitudinal direction to prepare three samples. Subsequently, each sample is processed with a FIB method or the like to perform thinning. In a case where the FIB method is used, formation of a carbon layer and a tungsten layer as protective films is performed as pre-processing for observing a TEM image of a cross section described below. The carbon layer is formed on a magnetic layer 13 side surface and a back layer 14 side surface of the magnetic tape T with a vapor deposition method, and then the tungsten layer is further formed on the magnetic layer 13 side surface with a vapor deposition method or a sputtering method. The thinning is performed in the longitudinal direction of the magnetic tape T. That is, a cross section parallel to both the longitudinal direction and the thickness direction of the magnetic tape T is formed by the thinning.

The obtained cross section of each thinned sample is observed with a transmission electron microscope (TEM) under the following conditions.
Apparatus: TEM (H9000NAR manufactured by Hitachi, Ltd.)
Acceleration voltage: 300 kV
Magnification: 100,000 times

Next, the thickness of the underlayer 12 is measured at least 10 positions in the longitudinal direction of the magnetic tape T using the obtained TEM image, and then these measured values are simply averaged (arithmetically averaged) to obtain the average thickness (nm) of the underlayer 12.

### (Average Thickness of Base Layer)

The average thickness of the base layer 11 can be determined as follows. First, for example, a magnetic tape T accommodated in a cartridge such as the magnetic recording cartridge 10A described below is unwound, and the magnetic tape T is cut out in a length of 250 mm at a position 30 m from a connection portion 221 between the magnetic tape T and a leader tape LT in the longitudinal direction to prepare a sample. In the present description, the “longitudinal direction” in the case of “longitudinal direction from a connection portion between a magnetic tape T and a leader tape LT” means a direction from one end on the leader tape LT side toward the other end on the opposite side.

Subsequently, layers other than the base layer 11 of the sample (that is, the non-magnetic layer (underlayer) 12, the magnetic layer 13, and the back layer 14) are removed with a solvent such as methyl ethyl ketone (MEK), dilute hydrochloric acid, or the like. Next, the thickness of the sample (base layer 11) is measured at five positions using a laser hologauge (LGH-110C) manufactured by Mitutoyo Corporation as a measuring device, and these measured values are simply averaged (arithmetically averaged) to calculate the average thickness of the base layer 11. Note that the five measurement positions are randomly selected from the sample so as to be different positions in the longitudinal direction of the magnetic tape T.

### (Average Thickness t_{b} of Back Layer)

The average thickness t_{b} of the back layer 14 is determined as follows. First, the average thickness (average total thickness) t_{T} of the magnetic tape T is measured. The method of measuring the average thickness tr (average total thickness) is as described above. Subsequently, the magnetic tape T accommodated in the cartridge 10A is unwound, and the magnetic tape T is cut out into a length of 250 mm at a position 30 m from the connection portion 221 between the magnetic tape T and the leader tape LT in the longitudinal direction to prepare a sample. Next, the back layer 14 of the sample is removed with a solvent such as methyl ethyl ketone (MEK), dilute hydrochloric acid and the like. Next, the thickness of the sample is measured at five positions using a laser hologauge (LGH-110C) manufactured by Mitutoyo Corporation, and these measured values are simply averaged (arithmetically averaged) to calculate the average t_{B} [μm]. Thereafter, the average thickness t_{b} [μm] of the back layer 14 is determined with the following formula. Note that the five measurement positions are randomly selected from the sample so as to be different positions in the longitudinal direction of the magnetic tape T.

$${t}_{b} [ µm ] = {t}_{T} [ µm ] - {t}_{B} [ µm ]$$

### (Average Thickness tₘ of Magnetic Layer)

The average thickness tₘ of the magnetic layer 13 is determined as follows. First, the magnetic tape T accommodated in the cartridge 10A is unwound, and the magnetic tape T is cut out into a length of 250 mm at each of three positions 10 m, 30 m, and 50 m, respectively, from the connection portion 221 between the magnetic tape T and the leader tape LT in the longitudinal direction to prepare three samples. Subsequently, each sample is processed with a FIB method or the like to perform thinning. In a case where the FIB method is used, formation of a carbon layer and a tungsten layer as protective films is performed as pre-processing for observing a TEM image of a cross section described below. The carbon layer is formed on a magnetic layer 13 side surface and a back layer 14 side surface of the magnetic tape T with a vapor deposition method, and then the tungsten layer is further formed on the magnetic layer 13 side surface with a vapor deposition method or a sputtering method. The thinning is performed in the longitudinal direction of the magnetic tape T. That is, a cross section parallel to both the longitudinal direction and the thickness direction of the magnetic tape T is formed by the thinning.

The obtained cross section of each thinned sample is observed with a transmission electron microscope (TEM) under the following conditions, and thus a TEM image of each thinned sample is obtained. Note that the magnification and the acceleration voltage may be appropriately adjusted according to the type of the apparatus.
Apparatus: TEM (H9000NAR manufactured by Hitachi, Ltd.)
Acceleration voltage: 300 kV
Magnification: 100,000 times

Next, the thickness of the magnetic layer 13 is measured at 10 positions of each thinned sample using the obtained TEM image of each thinned sample. Note that the 10 measurement positions of each thinned sample are randomly selected from the sample so as to be different positions in the longitudinal direction of the magnetic tape T. The average obtained by simply averaging (arithmetically averaging) the obtained measured values of the thinned samples (the thicknesses of the magnetic layer 13 at 30 points in total) is regarded as the average thickness tₘ [nm] of the magnetic layer 13.

### (Squareness Ratio Rs2 in Vertical Direction)

The squareness ratio Rs2 of the magnetic recording medium of the present technology in the vertical direction (thickness direction) can be preferably 50% or more, more preferably 60% or more, and even more preferably 70% or more. When the squareness ratio Rs2 is 50% or more, the vertical orientation of the magnetic powder is sufficiently high, so that a more excellent SNR can be obtained. Therefore, a more excellent electromagnetic conversion characteristic can be obtained. Furthermore, the servo signal shape is improved, and control on the drive side is more easily performed.

In the present description, the vertical orientation of the magnetic recording medium may mean that the squareness ratio Rs2 of the magnetic recording medium is within the above-described numerical range (for example, 50% or more).

The squareness ratio Rs2 in the vertical direction is determined as follows. First, the magnetic tape T accommodated in the magnetic recording cartridge 10A is unwound, and the magnetic tape T is cut out in a length of 250 mm at a position 30 m from the connection portion between the magnetic tape T and the leader tape LT in the longitudinal direction to prepare a sample. The sample is punched into 6.25 mm×64 mm, and then folded in three to prepare a measurement sample of 6.25 mm×8 mm. Then, the M-H hysteresis loop of the measurement sample (the entire magnetic tape T) corresponding to the vertical direction (thickness direction) of the magnetic tape T is measured using a VSM. Next, the coating film (the underlayer 12, the magnetic layer 13, the back layer 14, and the like) are wiped using acetone, ethanol, or the like, and only the base layer 11 is left. Then, the obtained base layer 11 is punched into 6.25 mm×64 mm, and then folded in three to obtain a sample of 6.25 mm×8 mm for background correction (hereinafter, simply referred to as “sample for correction”). Thereafter, the M-H hysteresis loop of the sample for correction (base layer 11) corresponding to the vertical direction of the base layer 11 (vertical direction of the magnetic recording medium 10) is measured using a VSM.

In the measurement of the M-H hysteresis loop of the measurement sample (the entire magnetic tape T) and the M-H hysteresis loop of the sample for correction (base layer 11), a high-sensitivity vibrating sample magnetometer “model VSM-P7-15” manufactured by Toei Industry Co., Ltd. is used. The measurement conditions are as follows: measurement mode: full loop, maximum magnetic field: 15 kOe, magnetic field step: 40 bits, time constant of locking amp: 0.3 sec, waiting time: 1 sec, and MH average number: 20.

After obtaining the M-H hysteresis loop of the measurement sample (the entire magnetic tape T) and the M-H hysteresis loop of the sample for correction (base layer 11), the M-H hysteresis loop of the sample for correction (base layer 11) is subtracted from the M-H hysteresis loop of the measurement sample (the entire magnetic tape T) to perform background correction, and an M-H hysteresis loop after background correction is obtained. For calculation of the background correction, a measurement/analysis program attached to “model VSM-P7-15” is used.

The saturation magnetization amount Ms (emu) and the residual magnetization Mr (emu) of the obtained M-H hysteresis loop after background correction are substituted in the following formula to calculate the squareness ratio Rs2(%). Note that every measurement of the M-H hysteresis loop described above is performed at 25° C. Furthermore, when the M-H hysteresis loop is measured in the vertical direction of the magnetic tape T, “demagnetizing field correction” is not performed. Note that for this calculation, a measurement/analysis program attached to “model VSM-P7-15” is used.

$$Squareness ratio Rs 2 ( \% ) = ( Mr / Ms ) \times 100$$

### (Squareness Ratio Rs1 in Longitudinal Direction)

The squareness ratio Rs1 of the magnetic recording medium of the present technology in the longitudinal direction (traveling direction) can be preferably 40% or less, more preferably 35% or less, and still more preferably 30% or less. When the squareness ratio Rs1 in the longitudinal direction is 40% or less, the vertical orientation of the magnetic powder is sufficiently high, so that a more excellent SNR can be obtained. Therefore, a more excellent electromagnetic conversion characteristic can be obtained. Furthermore, the servo signal shape is improved, and control on the drive side is more easily performed.

In the present description, the vertical orientation of the magnetic recording medium may mean that the squareness ratio Rs1 in the longitudinal direction of the magnetic recording medium is within the above numerical range (for example, 40% or less). The magnetic recording medium according to the present technology is preferably vertically oriented.

The squareness ratio Rs1 in the longitudinal direction is obtained in a similar manner to the squareness ratio Rs2 in the vertical direction except that the M-H hysteresis loop is measured in the longitudinal direction (traveling direction) of the magnetic tape T and the base layer 11.

The squareness ratio Rs2 in the vertical direction and the squareness ratio Rs1 in the longitudinal direction are set to desired values, for example, by adjusting the strength of the magnetic field applied to the coating material for forming a magnetic layer, the application time of the magnetic field to the coating material for forming a magnetic layer, the dispersion state of the magnetic powder in the coating material for forming a magnetic layer, or the concentration of the solid content in the coating material for forming a magnetic layer. Specifically, for example, as the strength of the magnetic field increases, the squareness ratio Rs1 in the longitudinal direction decreases, whereas the squareness ratio Rs2 in the vertical direction increases. In addition, as the application time of the magnetic field is longer, the squareness ratio Rs1 in the longitudinal direction decreases, whereas the squareness ratio Rs2 in the vertical direction increases. In addition, as the dispersion state of the magnetic powder is improved, the squareness ratio Rs1 in the longitudinal direction decreases, whereas the squareness ratio Rs2 in the vertical direction increases. In addition, as the concentration of the solid content decreases, the squareness ratio Rs1 in the longitudinal direction decreases, whereas the squareness ratio Rs2 in the vertical direction increases. Note that the adjustment methods described above may be used alone or in combination of two or more.

### (Coercive Force Hc1 in Vertical Direction)

The upper limit of the coercive force Hc1 in the vertical direction is 3000 Oe or less, more preferably 2900 Oe or less, and even more preferably 2850 Oe or less. A large coercive force Hc1 is preferable because it is less likely to be affected by thermal disturbance and a diamagnetic field. However, if the coercive force Hc1 exceeds 3000 Oe, saturation recording in the recording head may be difficult. Therefore, there is a part where recording cannot be performed, noise increases, and as a result, electromagnetic conversion characteristics (for example, C/N) deteriorate.

The lower limit of the coercive force Hc1 in the vertical direction is preferably 1500 Oe or more, more preferably 1600 Oe or more, and even more preferably 1700 Oe or more. When the coercive force Hc1 is 1500 Oe or more, it is possible to suppress a decrease in electromagnetic conversion characteristics (for example, C/N) under a high-temperature environment due to the influence of thermal disturbance and the influence of a diamagnetic field.

The coercive force Hc1 described above is obtained as follows. First, the measurement sample is cut out from the elongated magnetic recording medium 10, and an M-H loop of a whole of the measurement sample is measured in the vertical direction (thickness direction) of the measurement sample using a vibrating sample magnetometer (VSM). Next, the coating film (underlayer 12, magnetic layer 13, back layer 14, and the like) is wiped with acetone, ethanol, or the like, only the base layer 11 is left as a sample for background correction, and the M-H loop of the base layer 11 is measured in the vertical direction (thickness direction) of the base layer 11 using the VSM. Thereafter, the M-H loop of the base layer 11 is subtracted from the M-H loop of the entire measurement sample to obtain an M-H loop after the background correction. The coercive force Hc1 is obtained from the obtained M-H loop. Note that every measurement of the M-H loop described above is performed at 25° C. Furthermore, it is assumed that “demagnetizing field correction” when measuring the M-H loop in the vertical direction of the magnetic recording medium 10 is not performed.

### (Coercive Force Hc2 in Longitudinal Direction)

An upper limit of the coercive force Hc2 in the longitudinal direction is preferably 2000 Oe or smaller, more preferably 1900 Oe or smaller, and even more preferably 1800 Oe or smaller. When the coercive force Hc2 in the longitudinal direction is 2000 Oe or smaller, the magnetization reacts with a high degree of sensitivity by the magnetic field in the vertical direction from the recording head, so that an excellent recording pattern may be formed.

The lower limit of the coercive force Hc2 in the longitudinal direction is preferably 1000 Oe or more. When the coercive force Hc2 in the longitudinal direction is 1000 Oe or more, demagnetization due to leakage magnetic flux from the recording head can be suppressed.

The coercive force Hc2 described above is obtained in a similar manner to the coercive force Hc1 in the vertical direction except that the M-H loops of the entire measurement sample and the sample for background correction are measured in the direction corresponding to the longitudinal direction (traveling direction) of the magnetic recording medium 10.

### (4) Method of Manufacturing Magnetic Recording Medium

Next, a method of manufacturing the magnetic recording medium 10 having the above-described configuration will be described. First, a non-magnetic powder, a binding agent, and the like are kneaded and/or dispersed in a solvent to prepare a coating material for forming an underlayer (non-magnetic layer). Next, a magnetic powder, non-magnetic particles, a binding agent, and the like are kneaded and/or dispersed in a solvent to prepare a coating material for forming a magnetic layer. For the preparation of the coating material for forming a magnetic layer and the coating material for forming an underlayer (non-magnetic layer), for example, the following solvents, dispersing apparatus, and kneading apparatus can be used.

Examples of the solvent used in the preparation of the coating material described above include ketone-based solvents such as acetone, methyl ethyl ketone, methyl isobutyl ketone, cyclohexanone, and the like, alcohol-based solvents such as methanol, ethanol, propanol, and the like, ester-based solvents such as methyl acetate, ethyl acetate, butyl acetate, propyl acetate, ethyl lactate, ethylene glycol acetate, and the like, ether-based solvents such as diethylene glycol dimethyl ether, 2-ethoxyethanol, tetrahydrofuran, dioxane, and the like, aromatic hydrocarbon-based solvents such as benzene, toluene, xylene, and the like, and halogenated hydrocarbon-based solvents such as methylene chloride, ethylene chloride, carbon tetrachloride, chloroform, chlorobenzene, and the like. One of these solvents may be used, or a mixture of two or more thereof may be used.

As the kneading apparatus used in the preparation of the coating material described above, for example, a kneading apparatus can be used such as a continuous biaxial kneader, a continuous biaxial kneader capable of diluting in multiple steps, a kneader, a press kneader, a roll kneader, or the like, but the kneading apparatus is not particularly limited thereto. Furthermore, as the dispersing apparatus used in the preparation of the coating material described above, for example, a dispersing apparatus can be used such as a bead mill, a roll mill, a ball mill, a horizontal sand mill, a vertical sand mill, a spike mill, a pin mill, a tower mill, a pearl mill (for example, “DCP Mill” manufactured by Nippon Eirich Co., Ltd., or the like), a homogenizer, an ultrasonic dispersing apparatus, or the like, but the dispersing apparatus is not particularly limited thereto.

Next, the coating material for forming an underlayer is applied to one principal surface of a base layer 11 and dried to form an underlayer 12. Subsequently, the coating material for forming a magnetic layer is applied onto the underlayer 12 and dried to form a magnetic layer 13 on the non-magnetic layer 12.

The ratio of the magnetic powder to the binder in the coating material for forming a magnetic layer affects dispersibility. The ratio P/B of the magnetic powder to the binder may be preferably 4 or more.

Note that, at the time of drying, the magnetic powder is magnetically oriented in the thickness direction of the base layer 11 with, for example, a solenoid coil. Furthermore, at the time of drying, for example, the magnetic powder may be magnetically oriented in the longitudinal direction (traveling direction) of the base layer 11 and then magnetically oriented in the thickness direction of the base layer 11 with a solenoid coil. The ratio Hc2/Hc1 of the holding force “Hc2” in the longitudinal direction to the holding force “Hc1” in the vertical direction can be reduced, and the degree of vertical orientation of the magnetic powder can be improved by performing such magnetic orientation processing. After forming the magnetic layer 13, a back layer 14 is formed on the other principal surface of the base layer 11. Thus, a magnetic recording medium 10 is obtained.

The ratio Hc2/Hc1 is, for example, set to a desired value by adjusting the strength of the magnetic field applied to the coating film of the coating material for forming a magnetic layer, the solid content concentration in the coating material for forming a magnetic layer, and drying conditions of the coating film of the coating material for forming a magnetic layer (the drying temperature and the drying time). The strength of the magnetic field applied to the coating film is preferably 2 times or more and 3 times or less the holding force of the magnetic powder. In order to further increase the ratio Hc2/Hc1, it is also preferable to magnetize the magnetic powder at a stage before the coating material for forming a magnetic layer is put in an orienting apparatus for magnetically orienting the magnetic powder. Note that methods of adjusting the ratio Hc2/Hc1 may be used alone or in combination of two or more thereof.

Thereafter, the obtained magnetic recording medium 10 is rewound around a large-diameter core, and curing treatment is performed. Finally, the magnetic recording medium 10 is calendered and then cut into a predetermined width (for example, a width of ½ inches). Thus, a target elongated magnetic recording medium 10 is obtained.

### (5) Recording and Reproducing Apparatus

### [Configuration of Recording and Reproducing Apparatus]

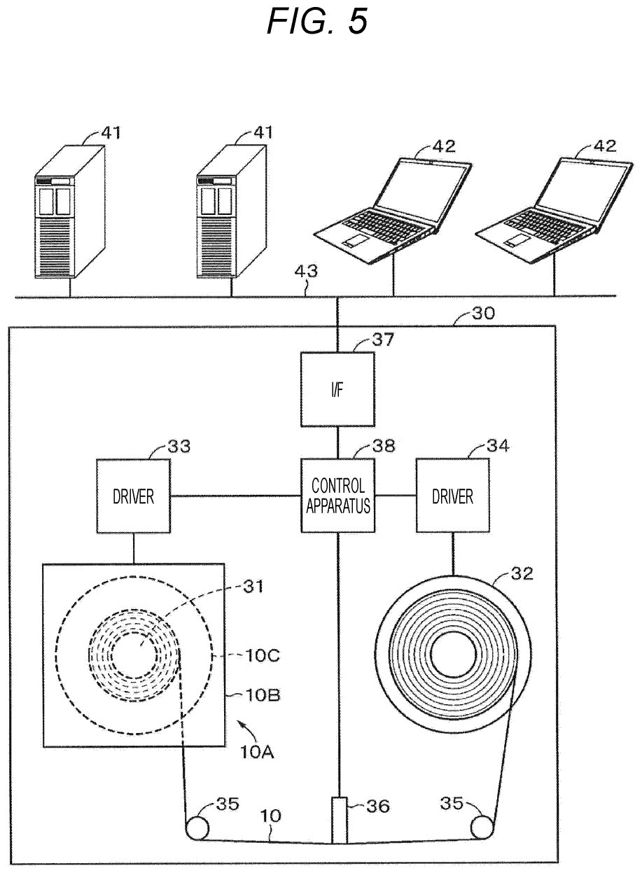

Next, an example of a configuration of a recording and reproducing apparatus 30 that performs recording and reproducing of the magnetic recording medium 10 having the above-described configuration will be described with reference to FIG. 5.

The recording and reproducing apparatus 30 may be configured to be capable of adjusting the tension applied to the magnetic recording medium 10 in the longitudinal direction. Furthermore, the recording and reproducing apparatus 30 has a configuration in which a magnetic recording cartridge 10A can be loaded. Here, in order to make the description easy, a case is described in which the recording and reproducing apparatus 30 has a configuration in which one magnetic recording cartridge 10A can be loaded, but the recording and reproducing apparatus 30 may have a configuration in which a plurality of magnetic recording cartridges 10A can be loaded.

The recording and reproducing apparatus 30 is preferably a timing servo type magnetic recording and reproducing apparatus. The magnetic recording medium of the present technology is suitable for use in a timing servo type magnetic recording and reproducing apparatus.

The recording and reproducing apparatus 30 is connected to information processors such as a server 41, a personal computer (hereinafter referred to as a “PC”) 42, and the like via a network 43, and is configured to be capable of recording data supplied from the information processors in the magnetic recording cartridge 10A. The shortest recording wavelength of the recording and reproducing apparatus 30 is preferably 100 nm or less, more preferably 75 nm or less, still more preferably 60 nm or less, and particularly preferably 50 nm or less.

As illustrated in FIG. 5, the recording and reproducing apparatus includes a spindle 31, a reel 32 on the recording and reproducing apparatus side, a spindle driver 33, a reel driver 34, a plurality of guide rollers 35, a head unit 36, a communication interface (hereinafter, I/F) 37, and a control apparatus 38.

The spindle 31 is configured so that the magnetic recording cartridge 10A can be loaded thereon. The magnetic recording cartridge 10A conforms to the Linear Tape-Open (LTO) standard and includes a cartridge case 10B accommodating a rotatable single reel 10C in which the magnetic recording medium 10 is wound. In the magnetic recording medium 10, a servo pattern in an inverted V-shape is recorded in advance as a servo signal. The reel 32 is configured to be capable of fixing a leading end of the magnetic recording medium 10 drawn out from the magnetic recording cartridge 10A.

The present technology also provides a magnetic recording cartridge including the magnetic recording medium according to the present technology. In the magnetic recording cartridge, for example, the magnetic recording medium may be wound around a reel, and may be accommodated in a case in a state of being wound around the reel.

The spindle driver 33 is an apparatus that rotationally drives the spindle 31. The reel driver 34 is an apparatus that rotationally drives the reel 32. When data is recorded in or reproduced from the magnetic recording medium 10, the spindle driver 33 and the reel driver 34 rotationally drive the spindle 31 and the reel 32, respectively, to make the magnetic recording medium 10 travel. The guide rollers 35 are a roller for guiding travel of the magnetic recording medium 10.

The head unit 36 includes a plurality of recording heads for recording data signals in the magnetic recording medium 10, a plurality of reproducing heads for reproducing the data signals recorded in the magnetic recording medium 10, and a plurality of servo heads for reproducing the servo signals recorded in the magnetic recording medium 10. As the recording head, for example, a ring head can be used, but the type of the recording head is not limited thereto.

The communication I/F 37 is for communicating with the information processors such as the server 41, the PC 42, and the like, and is connected to the network 43.

The control apparatus 38 controls a whole of the recording and reproducing apparatus 30. For example, in response to a request from the information processors such as the server 41, the PC 42, and the like, the control apparatus 38 records the data signal supplied from the information processor in the magnetic recording medium 10 by the head unit 36. Furthermore, in response to a request from the information processors such as the server 41, the PC 42, and the like, the control apparatus 38 reproduces the data signal recorded in the magnetic recording medium 10 by the head unit 36 and supplies the data signal to the information processor.

### [Operation of Recording and Reproducing Apparatus]

Next, an operation of the recording and reproducing apparatus 30 having the above-described configuration will be described.

First, the magnetic recording cartridge 10A is loaded in the recording and reproducing apparatus 30, a leading end of the magnetic recording medium 10 is drawn out and transferred to the reel 32 via the plurality of guide rollers 35 and the head unit 36, and the leading end of the magnetic recording medium 10 is attached to the reel 32.

Next, when an operation unit (not illustrated) is operated, the spindle driver 33 and the reel driver 34 are driven by control of the control apparatus 38, and the spindle 31 and the reel 32 are rotated in the same direction so that the magnetic recording medium 10 travels from the reel 10C toward the reel 32. As a result, while the magnetic recording medium 10 is wound around the reel 32, the head unit 36 records information in the magnetic recording medium 10 or reproduces the information recorded in the magnetic recording medium 10.

Furthermore, when the magnetic recording medium 10 is rewound around the reel 10C, the spindle 31 and the reel 32 are rotationally driven in the direction opposite to the above direction, and thus the magnetic recording medium 10 travels from the reel 32 to the reel 10C. Also at the time of rewinding, the head unit 36 records information in the magnetic recording medium 10 or reproduces the information recorded in the magnetic recording medium 10.

### (6) Modified Examples

The magnetic recording medium 10 may be incorporated in a library apparatus. That is, the present technology also provides a library apparatus including at least one magnetic recording medium 10. The library apparatus has a configuration capable of adjusting the tension applied to the magnetic recording medium 10 in the longitudinal direction, and may include a plurality of the above-described recording and reproducing apparatus 30.

### 3. Second Embodiment

### (1) Embodiment of Magnetic Recording Cartridge

### [Configuration of Cartridge]

The present technology also provides a magnetic recording cartridge (also referred to as a tape cartridge) including the magnetic recording medium according to the present technology. In the magnetic recording cartridge, the magnetic recording medium may be wound around, for example, a reel. The magnetic recording cartridge may include, for example, a communication unit that communicates with a recording and reproducing apparatus, a storage unit, and a control unit that stores information received from the recording and reproducing apparatus via the communication unit in the storage unit, reads the information from the storage unit in response to a request from the recording and reproducing apparatus, and transmits the information to the recording and reproducing apparatus via the communication unit. The information may include adjustment information for adjusting the tension applied to the magnetic recording medium in the longitudinal direction.

An example of a configuration of a magnetic recording cartridge 10A including the magnetic recording medium T having the above-described configuration will be described with reference to FIG. 6.

FIG. 6 is an exploded perspective view illustrating an example of a configuration of a magnetic recording cartridge 10A. The magnetic recording cartridge 10A is a magnetic recording cartridge conforming to the Linear Tape-Open (LTO) standard, and includes, inside a cartridge case 10B including a lower shell 212A and an upper shell 212B, a reel 10C in which a magnetic tape (tape-shaped magnetic recording medium) T is wound, a reel lock 214 and a reel spring 215 for locking rotation of the reel 10C, a spider 216 for unlocking the locking state of the reel 10C, a slide door 217 for opening and closing a tape outlet 212C provided in the cartridge case 10B across the lower shell 212A and the upper shell 212B, a door spring 218 for energizing the slide door 217 to the closed position of the tape outlet 212C, a write protect 219 for preventing erroneous erasure, and a cartridge memory 211. The reel 10C has a substantially disk-like shape having an opening at the center portion, and includes a reel hub 213A and a flange 213B including a hard material such as plastic or the like. A leader tape LT is connected to one end portion of the magnetic tape T. A leader pin 220 is provided at a leading end of the leader tape LT.

The cartridge memory 211 is provided in the vicinity of one corner of the magnetic recording cartridge 10A. In a state where the magnetic recording cartridge 10A is loaded in a recording and reproducing apparatus 80, the cartridge memory 211 faces a reader/writer (not illustrated) of the recording and reproducing apparatus 80. The cartridge memory 211 communicates with a recording and reproducing apparatus 30, specifically, a reader/writer (not illustrated) in accordance with a wireless communication standard conforming to the LTO standard.

### (2) Modified Example of Magnetic Recording Cartridge

### [Configuration of Cartridge]

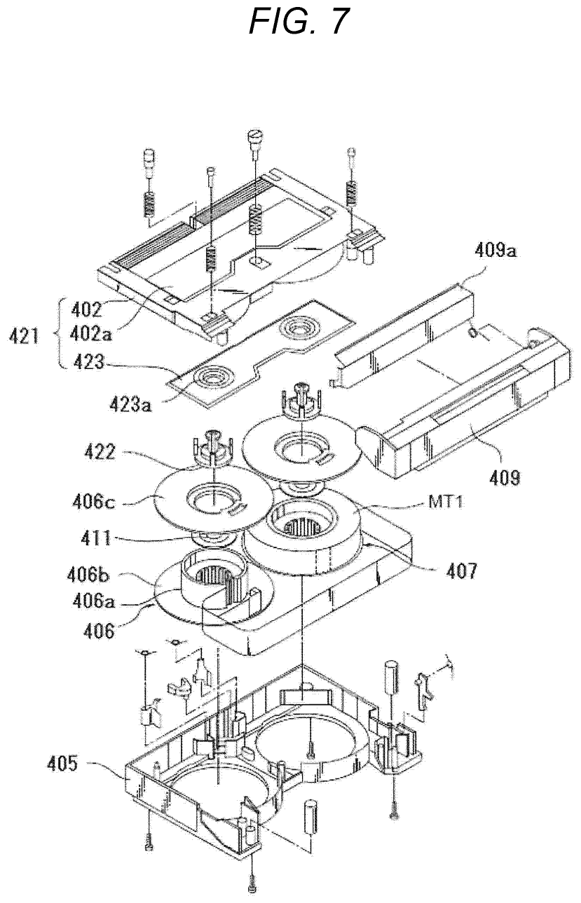

In one embodiment of the magnetic recording cartridge described above, a case where the magnetic tape cartridge is a one-reel cartridge is described, but the magnetic recording cartridge of the present technology may be a two-reel cartridge. That is, the magnetic recording cartridge of the present technology may have one or a plurality of (for example, two) reels around which the magnetic tape is wound. Hereinafter, an example of the magnetic recording cartridge of the present technology having two reels will be described with reference to FIG. 7.

FIG. 7 is an exploded perspective view illustrating an example of a configuration of a two-reel type cartridge 421. The cartridge 421 includes an upper half 402 including a synthetic resin, a transparent window member 423 fitted and fixed to a window portion 402a opened in an upper surface of the upper half 402, reel holders 422 fixed to an inner side of the upper half 402 and preventing uplift of reels 406 and 407, a lower half 405 corresponding to the upper half 402, the reels 406 and 407 stored in a space formed by combining the upper half 402 and the lower half 405, a magnetic tape MT1 wound around the reels 406 and 407, a front lid 409 closing a front side opening formed by combining the upper half 402 and the lower half 405, and a back lid 409A protecting the magnetic tape MT1 exposed at the front side opening.

The reel 406 includes a lower flange 406b having a cylindrical hub portion 406a, in a central portion, around which the magnetic tape MT1 is wound, an upper flange 406c having substantially the same size as the lower flange 406b, and a reel plate 411 interposed between the hub portion 406a and the upper flange 406c. The reel 407 has a configuration similar to that of the reel 406.

The window member 423 is provided with attachment holes 423a at positions corresponding to the reels 406 and 407, respectively, for assembling the reel holders 422 as reel holding units that prevent the reels from being lifted up. The magnetic tape MT1 is similar to the magnetic tape T in the first embodiment.

The present technology can also adopt the following configurations.

[1]

A magnetic recording medium including a magnetic layer, in which
a Cl/Fe atomic ratio α of a magnetic layer surface measured by an X-ray photoelectron spectrometer is 0.60 or more and 5.70 or less.
   [2]

The magnetic recording medium according to [1], in which the Cl/Fe atomic ratio α of the magnetic layer surface measured by the X-ray photoelectron spectrometer is 0.65 or more and 5.70 or less.

[3]

The magnetic recording medium according to [1] or [2], in which an N/Fe atomic ratio β of the magnetic layer surface measured by the X-ray photoelectron spectrometer is 0.16 or more and 0.98 or less.

[4]

The magnetic recording medium according to any one of [1] to [3], in which an (Cl+N)/Fe atomic ratio γ of the magnetic layer surface measured by the X-ray photoelectron spectrometer is 0.60 or more and 6.69 or less.

[5]

The magnetic recording medium according to any one of [1] to [4], in which a P/B ratio in the magnetic layer is 4 or more.

[6]

The magnetic recording medium according to any one of [1] to [5], in which the magnetic layer contains a magnetic powder having an Fe atom.

[7]

The magnetic recording medium according to [6], in which the magnetic powder having an Fe atom is hexagonal ferrite particles.

[8]

The magnetic recording medium according to any one of [1] to [7], in which the magnetic layer contains a binder having a Cl atom.

[9]

The magnetic recording medium according to [8], in which the binder having a Cl atom is a chlorine-based resin.

The magnetic recording medium according to any one of [3] to [9], in which the magnetic layer contains a binder having an N atom.

The magnetic recording medium according to any one of [1] to [10], in which an average particle volume of the magnetic powder is 1600 nm³ or less.

The magnetic recording medium according to any one of [1] to [11], in which a squareness ratio in a vertical direction of the magnetic recording medium is 50% or more.

The magnetic recording medium according to any one of [1] to [12], in which the magnetic recording medium has an average thickness tr of 5.5 μm or less.

The magnetic recording medium according to any one of [1] to [13], in which the magnetic layer has a thickness of 80 nm or less.

The magnetic recording medium according to any one of [1] to [14], in which the base layer has an average thickness t_{B} of 4.8 μm or less.

The magnetic recording medium according to any one of [1] to [15], in which the magnetic recording medium has an SNR of 1.4 dB or more.

The magnetic recording medium according to any one of [1] to [16], further including a magnetic layer, an underlayer, and a base layer in this order.

The magnetic recording medium according to [17], in which the underlayer contains a non-magnetic powder.

A magnetic recording cartridge including the magnetic recording medium according to any one of [1] to [18] in a state of being wound around a reel, the magnetic recording medium accommodated in a case.

### 4. EXAMPLES

Hereinafter, the present technology will be described more specifically with reference to Examples, but the present technology is not limited only to these Examples. Note that values of various parameters appearing in these Examples are obtained by the above-described measurement methods unless otherwise specified.

Magnetic tapes were obtained as described in Comparative Examples 1 to 3 and Examples 1 to 5 below.

### Example 1

### (Step of Preparing Coating Material for Forming Magnetic Layer)

A coating material for forming a magnetic layer was prepared as follows. First, a first composition having the following formulation was kneaded with an extruder. Next, the kneaded first composition and a second composition having the following formulation were added to a stirring tank equipped with a disperser and premixing was performed. Subsequently, dyno mill mixing was further performed, and filter treatment was performed to prepare a coating material for forming a magnetic layer.

### (First Composition)

Barium ferrite (BaFe₁₂O₁₉) magnetic powder (hexagonal plate-like shape, average aspect ratio: 2.6, average particle volume: 1000 nm³): 100 parts by mass

Vinyl chloride-based resin (cyclohexanone solution: 30 mass %): 50 parts by mass

(degree of polymerization: 300, Mn=10000, containing OSO₃K=0.07 mmol/g and secondary OH=0.3 mmol/g as polar groups).

Aluminum oxide powder: 3 parts by mass (α-Al₂O₃, average particle diameter: 0.1 μm)

### (Second Composition)

Carbon black: 1 parts by mass (manufactured by Tokai Carbon, trade name: SEAST TA)

Polyurethane resin (resin solution: blending amount of polyurethane resin: 30 mass %, blending amount of cyclohexanone: 70 mass %): 5.56 parts by mass

(polyurethane resin: number average molecular weight Mn=25000, Tg: 110° C.)

n-Butyl stearate: 2 parts by mass

Methyl ethyl ketone: 121.3 parts by mass

Toluene: 121.3 parts by mass

Cyclohexanone: 60.7 parts by mass

Finally, 3.3 parts by mass of polyisocyanate (trade name: Coronate L, manufactured by Tosoh Corporation) as a curing agent and 2 parts by mass of stearic acid were added to the coating material for forming a magnetic layer prepared as described above. The P/B ratio in the obtained coating material for forming a magnetic layer was 4.

### (Step of Preparing Coating Material for Forming Underlayer)

A third composition having the following formulation was kneaded with an extruder. Next, the kneaded third composition and a fourth composition having the following formulation were added to a stirring tank equipped with a disperser, and premixing was performed. Subsequently, mixing was further performed using a bead mill ECM-PRO (manufactured by SHINMARU ENTERPRISES CORPORATION) at a circulation flow rate of 500 L/h to 2000 L/h for a treatment time in the bead mill of 100 minutes, and then filter treatment was performed to prepare a coating material for forming an underlayer.

### (Third Composition)

Acicular iron oxide powder: 100 parts by mass

(α-Fe₂O₃, average long axis length: 0.15 μm) Vinyl chloride-based resin: 55.6 parts by mass

(resin solution: resin content: 30 mass %, cyclohexanone: 70 mass %)

### (Fourth Composition)

Carbon black: 30 parts by mass

(average particle diameter: 20 nm)

Polyurethane-based resin UR8200 (manufactured by TOYOBO CO., LTD.): 18.5 parts by mass

n-Butyl stearate: 2 parts by mass

Methyl ethyl ketone: 223.0 parts by mass

Toluene: 223.0 parts by mass

Cyclohexanone: 49.6 parts by mass

Finally, 2 parts by mass of polyisocyanate (trade name: Coronate L, manufactured by Tosoh Corporation) as a curing agent and 2 parts by mass of stearic acid were added to the coating material for forming an underlayer prepared as described above.

### (Step of Preparing Coating Material for Forming Back Layer)

A coating material for forming a back layer was prepared as follows. The following raw materials were mixed in a stirring tank equipped with a disperser and subjected to filter treatment to prepare the back layer forming coating material. Carbon black (manufactured by Asahi Carbon Co., Ltd., trade name: #80): 100 parts by mass

Polyester polyurethane: 100 parts by mass

(resin solution: blending amount of polyurethane resin: 30 mass %, blending amount of cyclohexanone: 70 mass %)

(manufactured by Nippon Polyurethane Industry Co., Ltd., trade name: N-2304)

Methyl ethyl ketone: 500 parts by mass

Toluene: 400 parts by mass

Cyclohexanone: 100 parts by mass

Polyisocyanate (trade name: Coronate L, manufactured by Tosoh Corporation): 10 parts by mass

### (Film Forming Step)

A magnetic tape was prepared as described below using the coating materials prepared as described above.

First, as a support body to be a base layer of a magnetic tape, a PEN film (base film) having an elongated shape and an average thickness of 3.60 μm was prepared. Next, the coating material for forming an underlayer was applied onto one principal surface of the PEN film and dried to form an underlayer on the one principal surface of the PEN film so that the underlayer in a final product had an average thickness of 1.2 μm. Next, the coating material for forming a magnetic layer was applied onto the underlayer and dried to form a magnetic layer on the underlayer so that the magnetic layer in a final product had an average thickness of 0.07 μm. Furthermore, the magnetic layer was subjected to vertical orientation processing using a solenoid coil.

Subsequently, the coating material for forming a back layer was applied onto the other principal surface of the PEN film on which the underlayer and the magnetic layer were formed and dried, and thus a back layer was formed so that the back layer in a final product had an average thickness of 0.45 μm. Then, the PEN film on which the underlayer, the magnetic layer, and the back layer were formed was subjected to curing treatment. Thereafter, calender processing was performed to smooth the surface of the magnetic layer.

### (Cutting Step)

The magnetic tape obtained as described above was cut into a width of ½ inches (12.65 mm). Thus, a magnetic tape having an elongated shape was obtained.

The magnetic tape having a width of ½ inches was wound around a reel provided in a cartridge case to obtain a multi-winding magnetic recording cartridge.

A servo signal was recorded in the magnetic tape with a servo track writer. The servo signal included rows of magnetic patterns in an inverted V-shape, and the magnetic patterns were recorded in advance in two or more rows in parallel in the longitudinal direction at a known interval (hereinafter, referred to as a “known interval between magnetic pattern rows recorded in advance”).

For the magnetic recording cartridge, as described in “(3) Physical Properties and Structure” in 2. above, the Cl/Fe atomic ratio α, the N/Fe atomic ratio β, and the (Cl+N)/Fe atomic ratio γ on the surface of the magnetic layer were measured using an XPS apparatus. These measurement results are shown in Table 2 below.

For the magnetic recording cartridge, the squareness ratio Rs2 in the vertical direction was measured as described in “(3) Physical Properties and Structure” in 2. above.

For the magnetic recording cartridge, the coercive force Hc1 in the vertical direction was measured as described in “(3) Physical Properties and Structure” in 2. above.

### Example 2

A magnetic tape was obtained by the same method as in Example 1 except that the P/B ratio in the magnetic layer was set to 5. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### Example 3

A magnetic tape was obtained by the same method as in Example 1 except that the P/B ratio in the magnetic layer was set to 2 and the magnetic layer was not subjected to the vertical orientation processing. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### Example 4

A magnetic tape was obtained by the same method as in Example 1 except that the magnetic layer was not subjected to the vertical orientation processing. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### Example 5

A magnetic tape was obtained by the same method as in Example 1 except that the P/B ratio in the magnetic layer was set to 5 and the magnetic layer was not subjected to the vertical orientation processing. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### Comparative Example 1

A magnetic tape was obtained by the same method as in Example 1 except that the P/B ratio in the magnetic layer was set to 2. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### Comparative Example 2

A magnetic tape was obtained by the same method as in Example 1 except that the P/B ratio in the magnetic layer was set to 7.5. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### Comparative Example 3

A magnetic tape was obtained by the same method as in Example 1 except that the P/B ratio in the magnetic layer was set to 7.5 and the magnetic layer was not subjected to the vertical orientation processing. Furthermore, a magnetic recording cartridge accommodating the magnetic tape was obtained in a manner similar to that in Example 1.

For the magnetic recording cartridge, the Cl/Fe atomic ratio α, the N/Fe atomic ratio β, and the (Cl+N)/Fe atomic ratio γ of the magnetic layer surface were calculated in the same manner as in Example 1. The results are shown in Table 2 as in Example 1.

### [Electromagnetic Conversion Characteristic (SNR)]

The magnetic recording medium according to the present technology preferably has an SNR of 1.4 dB or more. The SNR of the magnetic tape on which the servo pattern was written was evaluated as follows. The electromagnetic conversion characteristics (SNR) of the magnetic tape in a 25 degrees C. environment were measured using a ½ inch tape traveling device (MTS Transport, manufactured by Mountain Engineering II, Inc.) equipped with a recording/reproducing head and a recording/reproducing amplifier. A ring head with a gap length of 0.2 μm was used as the recording head, and a GMR head with an inter-shield distance of 0.1 μm was used for as reproducing head. A relative speed was 6 m/s, a recording clock frequency was 160 MHz, and a recording track width was 2.0 μm. Furthermore, the SNR was calculated on the basis of the method disclosed in the following document. The results are indicated in Table 2.
Y. Okazaki: “An Error Rate Emulation System.”, IEEE Trans. Man., 31, pp. 3093-3095 (1995)

### [Dynamic Friction Coefficient]

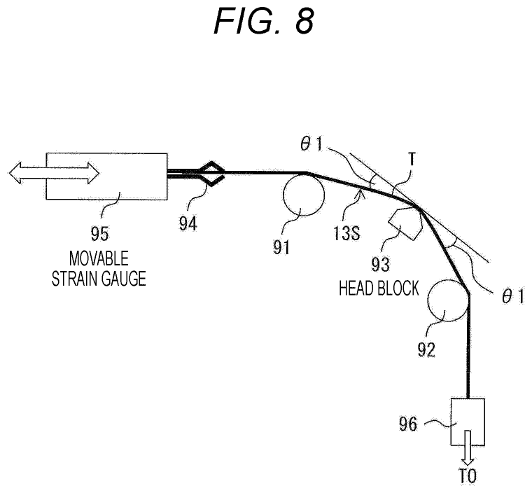

The dynamic friction coefficient is determined as follows. First, as illustrated in FIG. 8, the magnetic recording medium 10 having a width of ½ inches is placed on two cylindrical guide rolls 91 and 92 having a diameter of one inch and arranged in parallel to be separated from each other so that the surface 13S of the magnetic layer 13 is in contact with the two guide rolls 91 and 92. A positional relationship between the two guide rolls 91 and 92 is fixed.

Next, the magnetic recording medium 10 is brought into contact with a head block (for recording and reproduction) 93 mounted on an LTO5 drive so that a surface 13S of the magnetic layer 13 is in contact with the head block, and a contact angle θ₁ [°]=10° is satisfied, one end of the magnetic recording medium 10 is held by a holding jig 94 and connected to a movable strain gauge 95, and a weight 96 is suspended from the other end of the magnetic recording medium 10 to apply a tension T0 of 0.8 N. Note that the head block 93 is fixed at a position where the contact angle θ₁ [°] is 10°. Thereby, the positional relationship between the guide rolls 91 and 92 and the head block 93 is also fixed.

Next, the magnetic recording medium 10 is slid by 55 mm toward the movable strain gauge 95 at a speed of 5 mm/s with respect to the head block 93 by the movable strain gauge 95. An output value (voltage) of the movable strain gauge 95 at the time of sliding is converted into T [N] on the basis of a linear relationship (described later) between an output value acquired in advance and a load. Thereafter, the dynamic friction coefficient is obtained from the following equation.

$${μ}_{A} = \frac{1}{( 2 {θ}_{1} [ ° ] ) \times ( Π / 180 )} \times ln ( \frac{{T}_{ave} [ N ]}{{T}_{0} [ N ]} ) \qquad [ Mathematical Formula 2 ]$$

The above-described linear relationship is obtained as follows. That is, an output value (voltage) of the movable strain gauge 95 is obtained in a case where a load of 0.5 N is applied to the movable strain gauge, and in a case where a load of 1.0 N is applied to the movable strain gauge 95, respectively. A linear relationship between the output value and the load is obtained from the obtained two output values and the two loads. Using the linear relationship, the output value (voltage) from the movable strain gauge 95 during sliding is converted into T [N] as described above.

TABLE 2

| | | | | | | | | | Carbon | |
|---|---|---|---|---|---|---|---|---|---|---|
| | | | | | | | | Alumina | black | |
| | Thickness | Thickness | Thickness | Thickness | Total | | P/B | amount in | amount in | |
| | of magnetic | of | of base | of back | thickness | | ratio in | magnetic | magnetic | P/B |
| | layer | underlayer | layer | layer | of tape | Orientation | magnetic | layer | layer | ratio in |
| | (μm) | (μm) | (μm) | (μm) | (μm) | presence | layer | (PHP) | (PHP) | underlayer |
| Example 1 | 0.07 | 1.2 | 3.6 | 0.45 | 5.32 | Vertical | 4 | 3 | 1 | 3.49 |
| Example 2 | 0.07 | 1.2 | 3.6 | 0.45 | 5.32 | Vertical | 5 | 3 | 1 | 3.49 |
| Example 3 | 0.07 | 1.2 | 3.6 | 0.45 | 5.32 | No | 2 | 3 | 1 | 3.49 |
| | | | | | | orientation | | | | |
| Example 4 | 0.07 | 1.2 | 3.6 | 0.45 | 5.32 | No | 4 | 3 | 1 | 3.49 |
| | | | | | | orientation | | | | |
| Example 5 | 0.07 | 1.2 | 3.6 | 0.45 | 5.32 | No | 5 | 3 | 1 | 3.49 |
| | | | | | | orientation | | | | |
| Comparative | 0.07 | 1.2 | 3.6 | 0.45 | 5.32 | Vertical | 2 | 3 | 1 | 3.49 |
| Example 1 | | | | | | | | | | |
| Comparative | 0.07 | 1.2 | 3.6 | 0.45 | 5.32 | Vertical | 7.5 | 3 | 1 | 3.49 |
| Example 2 | | | | | | | | | | |
| Comparative | 0.07 | 1.2 | 3.6 | 0.45 | 5.32 | No | 7.5 | 3 | 1 | 3.49 |
| Example 3 | | | | | | orientation | | | | |

| | | | | Coercive | Squareness | Coercive | Squareness | | |
|---|---|---|---|---|---|---|---|---|---|
| | | | | force | ratio | force | ratio | | |
| | | | (Cl + | Hc2 in | Rs1 in | Hc1 in | Rs2 in | | |
| | Cl/Fe | N/Fe | N)/Fe | longitudinal | longitudinal | vertical | vertical | | |
| | atomic | atomic | atomic | direction | direction | direction | direction | | |
| | ratio | ratio | ratio | (Oe) | (%) | (Oe) | (%) | SNR | Friction |
| Example 1 | 0.840 | 0.240 | 1.075 | 1305 | 26 | 1961 | 55 | 1.54 | 0.820 |
| Example 2 | 0.680 | 0.163 | 0.840 | 1213 | 26 | 1969 | 55 | 1.58 | 0.571 |
| Example 3 | 3.290 | 0.569 | 3.860 | 1684 | 24 | 1888 | 45 | 0.50 | 0.417 |
| Example 4 | 0.570 | 0.166 | 0.740 | 1591 | 38 | 1789 | 45 | 1.34 | 0.810 |
| Example 5 | 0.480 | 0.111 | 0.591 | 1512 | 37 | 1753 | 44 | 1.36 | 0.519 |
| Comparative | 5.710 | 0.990 | 6.703 | 1392 | 28 | 2086 | 58 | Not | 0.833 |
| Example 1 | | | | | | | | measurable | |
| Comparative | 0.430 | 0.157 | 0.589 | 1282 | 28 | 1861 | 51 | 1.32 | Sticking |
| Example 2 | | | | | | | | | |
| Comparative | 0.300 | 0.107 | 0.403 | 1559 | 39 | 1712 | 42 | 1.18 | Sticking |
| Example 3 | | | | | | | | | |

As shown in Table 2, as for the magnetic tapes of Examples 1 to 5, all of them had SNRs of 1.0 dB or more and low dynamic friction coefficients of 0.82 or less. On the other hand, regarding the magnetic tape of Comparative Example 1, SNR could not be measured, and regarding the magnetic tapes of Comparative Examples 2 and 3, sticking to the head occurred at the time of measuring the dynamic friction coefficient. From these results, it can be seen that the magnetic recording medium according to the present technology has excellent electromagnetic conversion characteristics (SNR) and can suppress an increase in friction.

Although embodiments and Examples of the present technology are specifically described above, the present technology is not limited to the embodiments and Examples described above, and various modifications based on the technical idea of the present technology may be made.

For example, the configurations, the methods, the steps, the shapes, the materials, the numerical values, and the like described in the embodiments and examples described above are merely examples, and different configurations, methods, steps, shapes, materials, numerical values, and the like may be used as needed. Furthermore, the chemical formulae of compounds and the like are representative and are not limited to the listed valences and the like as long as the compounds have a common name of the same compound.

Furthermore, the configurations, the methods, the steps, the shapes, the materials, the numerical values, and the like of the embodiments and Examples described above can be combined with each other without departing from the gist of the present technology.

Furthermore, in the present specification, a numerical range indicated by using “to” indicates a range including numerical values described before and after “to” as the minimum value and the maximum value, respectively. In the numerical ranges described in stages in the present description, the upper limit or the lower limit of a numerical range of a certain stage may be replaced with the upper limit or the lower limit of a numerical range of another stage. The materials exemplified in the present description may be used alone or in combination of two or more thereof unless otherwise specified.

### REFERENCE SIGNS LIST

10 Magnetic recording medium
11 Base layer
12 Underlayer
13 Magnetic layer
14 Back layer

1. A magnetic recording medium comprising a magnetic layer, wherein
a Cl/Fe atomic ratio α of a magnetic layer surface measured by an X-ray photoelectron spectrometer is 0.60 or more and 5.70 or less.

2. The magnetic recording medium according to claim 1, wherein the Cl/Fe atomic ratio α of the magnetic layer surface measured by the X-ray photoelectron spectrometer is 0.65 or more and 5.70 or less.

3. The magnetic recording medium according to claim 1, wherein an N/Fe atomic ratio β of the magnetic layer surface measured by the X-ray photoelectron spectrometer is 0.16 or more and 0.98 or less.

4. The magnetic recording medium according to claim 1, wherein an (Cl+N)/Fe atomic ratio γ of the magnetic layer surface measured by the X-ray photoelectron spectrometer is 0.60 or more and 6.69 or less.

5. The magnetic recording medium according to claim 1, wherein a P/B ratio in the magnetic layer is 4 or more.

6. The magnetic recording medium according to claim 1, wherein the magnetic layer contains a magnetic powder having an Fe atom.

7. The magnetic recording medium according to claim 6, wherein the magnetic powder having an Fe atom is hexagonal ferrite particles.

8. The magnetic recording medium according to claim 1, wherein the magnetic layer contains a binder having a Cl atom.

9. The magnetic recording medium according to claim 8, wherein the binder having a Cl atom is a chlorine-based resin.

10. The magnetic recording medium according to claim 3, wherein the magnetic layer contains a binder having an N atom.

11. The magnetic recording medium according to claim 1, wherein an average particle volume of the magnetic powder is 1600 nm³ or less.

12. The magnetic recording medium according to claim 1, wherein a squareness ratio in a vertical direction of the magnetic recording medium is 50% or more.

13. The magnetic recording medium according to claim 1, wherein the magnetic recording medium has an average thickness tr of 5.5 μm or less.

14. The magnetic recording medium according to claim 1, wherein the magnetic layer has a thickness of 80 nm or less.

15. The magnetic recording medium according to claim 1, wherein an average thickness t_{B} of the base layer is 4.8 μm or less.

16. The magnetic recording medium according to claim 1, wherein the magnetic recording medium has an SNR of 1.4 dB or more.

17. The magnetic recording medium according to claim 1, further comprising a magnetic layer, an underlayer, and a base layer in this order.

18. The magnetic recording medium according to claim 17, wherein the underlayer contains a non-magnetic powder.

19. A magnetic recording cartridge comprising the magnetic recording medium according to claim 1, the magnetic recording medium accommodated in a case in a state of being wound around a reel.
